(19) United States
(12) Patent Application Publication
(10) Pub. No.: US 2026/0369121 A1
(43) Pub. Date: Nov. 19, 2026

(54) Wheel Display Method and Apparatus, Device, Medium, and Program Product

(71) Applicant: Tencent Technology (Shenzhen) Company Limited, Shenzhen (CN)

(72) Inventors: Zhouchen Duan, Shenzhen (CN); Jiake Yu, Shenzhen (CN); Chenbiao Li, Shenzhen (CN)

(21) Appl. No.: 19/727,263

(22) Filed: Jul. 1, 2026

Related U.S. Application Data
(63) Continuation of application No. PCT/CN2025/104643, filed on Jun. 27, 2025.

(30) Foreign Application Priority Data
Aug. 9, 2024 (CN) 2024110937014

(51) Int. Cl. G07F 17/32; G07F 17/34

(52) U.S. Cl. CPC G07F 17/3211; G07F 17/323; G07F 17/34

(57) ABSTRACT

A method comprises: displaying a preparation interface; displaying, after the preparation interface is exited, that a player-controlled virtual character performs a virtual activity in a virtual environment; displaying, in response to a wheel triggering operation, a wheel control in a process in which the player-controlled virtual character performs the virtual activity; and displaying at least one type of virtual item on n wheel tabs surrounding a wheel center in the wheel control. A display sequence of the at least one type of virtual item on the n wheel tabs corresponds to a sorting sequence of the at least one type of virtual item in the preparation interface.

### RELATED APPLICATIONS

This application claims priority to PCT/CN2025/104643, filed on Jun. 27, 2025, which claims priority to Chinese Patent Application No. 202411093701.4, filed on Aug. 9, 2024 and entitled “WHEEL DISPLAY METHOD AND APPARATUS, DEVICE, MEDIUM, AND PROGRAM PRODUCT”, each of which is incorporated herein by reference in its entirety.

### FIELD OF THE TECHNOLOGY

Aspects of this application relate to the field of human-computer interaction, and in particular, to a wheel display method and apparatus, a device, a medium, and a program product.

### BACKGROUND OF THE DISCLOSURE

With development of internet technologies and improvement of terminal performance, human-computer interaction operations are developing toward greater convenience, thereby improving user experience. For example, in a game application on a terminal, there are many designs for improving human-computer interaction efficiency.

In the related art, in a battle process of a game, a player invokes a wheel control (also referred to as a wheel) in a part of a field-of-view picture through interaction with a game application. The wheel is an annular interactive interface in which a virtual item held by the player is displayed. The wheel does not completely block the field of view, yet helps the player quickly use the virtual item.

However, content in the wheel displayed in this method needs to be manually set in advance by the player. For example, when the wheel includes eight wheel tabs, virtual items corresponding to the eight wheel tabs at most need to be set in advance. This is excessively time-consuming.

### SUMMARY

This application provides a wheel display method and apparatus, a device, a medium, and a program product. The technical solution includes at least one of the following aspects.

According to an aspect of this application, a wheel display method is provided, which is performed by a computer device, and includes: displaying a preparation interface, the preparation interface including at least two types of virtual items carried by a player-controlled virtual character, and the at least two types of virtual items each corresponding to a sorting sequence; displaying, when (e.g., after) the preparation interface is exited, that the player-controlled virtual character performs a virtual activity in a virtual environment; displaying, in response to a wheel triggering operation, a wheel control in a process in which the player-controlled virtual character performs the virtual activity; and displaying at least one type of virtual item on n wheel tabs surrounding a wheel center in the wheel control. A display sequence of the at least one type of virtual item on the n wheel tabs corresponds to a sorting sequence of the at least one type of virtual item in the preparation interface, and n being a positive integer greater than 1.

According to another aspect of this application, a wheel display apparatus is provided, including: a display module, configured to display a preparation interface, the preparation interface including at least two types of virtual items carried by a player-controlled virtual character, and the at least two types of virtual items each corresponding to a sorting sequence; the display module being configured to display, after the preparation interface is exited, that the player-controlled virtual character performs a virtual activity in a virtual environment; and the display module being configured to: display, in response to a wheel triggering operation, a wheel control in a process in which the player-controlled virtual character performs the virtual activity, and display at least one type of virtual item on n wheel tabs surrounding a wheel center in the wheel control. A display sequence of the at least one type of virtual item on the n wheel tabs corresponds to a sorting sequence of the at least one type of virtual item in the preparation interface, and n being a positive integer greater than 1.

According to another aspect of this application, a computer device is provided, including a processor and a memory, the memory having at least one segment of program stored therein; and the processor being configured to execute the at least one segment of program in the memory to implement the foregoing wheel display method.

According to another aspect of this application, a non-transitory computer-readable storage medium is provided, the non-transitory computer-readable storage medium having at least one segment of program stored thereon, and the at least one segment of program being loaded and executed by a processor to implement the foregoing wheel display method.

According to another aspect of this application, a computer program product or a computer program is provided, the computer program product or the computer program including computer instructions, the computer instructions being stored in a computer-readable storage medium, a processor obtaining the computer instructions from the computer-readable storage medium, and the processor executing the computer instructions to implement the foregoing wheel display method.

The technical solutions provided in aspects of this application may include the following beneficial effects.

According to the method, the at least one type of virtual item is displayed on a plurality of wheel tabs, and the sorting sequence of the at least one type of virtual item in the preparation interface is associated with the display sequence of the at least one type of virtual item on the n wheel tabs. For example, the display sequence of the virtual item on the wheel tabs is associated with the sorting sequence of the virtual item in the preparation interface, so that the virtual item can be directly displayed on the plurality of wheel tabs of the wheel control in the associated display sequence in the sorting sequence of the virtual item in the preparation interface. Therefore, there is no need to manually set the virtual item displayed on the wheel tabs in advance, thereby reducing operations, and improving convenience of setting display of the wheel tabs.

For example, in the related art, when there are eight types of different virtual items in a preparation interface, a display sequence of the eight types of different virtual items on eight wheel tabs needs to be manually set, and at least eight operations are needed. According to the method, when there are eight types of different virtual items in the preparation interface, a display sequence of the eight types of different virtual items on eight wheel tabs can be automatically set in a sorting sequence of the eight types of different virtual items in the preparation interface, and no additional operation is needed, thereby improving human-computer interaction efficiency.

### BRIEF DESCRIPTION OF THE DRAWINGS

To describe the technical solutions in aspects of this application more clearly, the following briefly describes the accompanying drawings required for describing the aspects. Clearly, the accompanying drawings in the following descriptions show merely some aspects of this application, and a person of ordinary skill in the art may still derive other drawings from these accompanying drawings without creative efforts.

FIG. 1 is a schematic diagram of a computer system according to an aspect of this application.

FIG. 2 is a schematic diagram of a wheel display method according to an aspect of this application.

FIG. 3 is a schematic diagram of a wheel display method according to an aspect of this application.

FIG. 4 is a schematic diagram of a wheel display method according to an aspect of this application.

FIG. 5 is a flowchart of a wheel display method according to an aspect of this application.

FIG. 6 is a flowchart of a wheel display method according to an aspect of this application.

FIG. 7 is a schematic diagram of a wheel display method according to an aspect of this application.

FIG. 8 is a schematic diagram of a wheel display method according to an aspect of this application.

FIG. 9 is a schematic diagram of a wheel display method according to an aspect of this application.

FIG. 10 is a flowchart of a wheel display method according to an aspect of this application.

FIG. 11 is a schematic diagram of a wheel display method according to an aspect of this application.

FIG. 12 is a schematic diagram of a wheel display method according to an aspect of this application.

FIG. 13 is a flowchart of a wheel display method according to an aspect of this application.

FIG. 14 is a block diagram of a wheel display apparatus according to an aspect of this application.

FIG. 15 is a block diagram of a structure of a computer device according to an aspect of this application.

### DETAILED DESCRIPTION

To make objectives, technical solutions, and advantages of this application clearer, the following further describes implementations of this application in detail with reference to accompanying drawings.

Aspects are described in detail herein, and examples of the aspects are shown in the accompanying drawings. When the following descriptions involve the accompanying drawings, unless otherwise indicated, the same numerals in different accompanying drawings represent the same or similar elements. The implementations described in the following aspects do not indicate all implementations consistent with this application. Instead, the implementations are merely examples of apparatuses and methods that are described in detail in the appended claims and that are consistent with some aspects of this application.

Terms used in this application are merely intended to describe specific aspects but are not intended to limit this application. The terms “a”, “said” and “the” of singular forms used in this application and the appended claims are also intended to include plural forms, unless otherwise specified in the context clearly. The term “and/or” used herein indicates and includes any or all possible combinations of one or more associated listed items.

Object information (including but not limited to object device information, object personal information, and the like) and data (including but not limited to data configured for analysis, stored data, exhibited data, and the like) involved in this application are all information and data authorized by objects or fully authorized by all parties, and collection, use, and processing of relevant data need to comply with relevant laws, regulations, and standards of relevant countries and regions.

Although terms “first”, “second”, and the like may be used in this application to describe various pieces of information, these pieces of information are not limited by the terms. These terms are merely used to differentiate the same type of information. For example, without departing from the scope of this application, a first parameter may also be referred to as a second parameter. Similarly, a second parameter may also be referred to as a first parameter. Depending on the context, for example, a word “if” used herein may be explained as “while . . . ” or “when . . . ” or “in response to determining”.

First, some terms involved in this application are explained.

Virtual scene: It is a virtual scene displayed (or provided) when an application runs on a terminal. The virtual scene may be a simulated environment scene of a real world, may be a semi-simulated and semi-fictional three-dimensional environment scene, or may be an entirely fictional three-dimensional environment scene. The virtual scene may be any one of a two-dimensional virtual scene, a 2.5-dimensional virtual scene, or a three-dimensional virtual scene. The following examples are described by using an example in which the virtual scene is a three-dimensional virtual scene, but no limitation is imposed.

Virtual character: It is a movable object played by a player in a virtual scene. The virtual character may be a virtual person, a virtual animal, or an animation character, for example, a person or an animal displayed in a three-dimensional virtual scene. In one example, the virtual character is a three-dimensional model created based on a skeleton animation technology. Each virtual character has a shape and a volume in the three-dimensional virtual scene, and occupies a part of space in the three-dimensional virtual scene.

Wheel control: It is an annular interactive interface. A player can select an option in the wheel control for execution after invoking the wheel control in some interaction manners, and the wheel control may be briefly referred to as a wheel.

Preparation interface: It is an interface configured for viewing and managing a plurality of types of virtual items carried by a virtual character. On the preparation interface, a player may view a currently carried virtual item, and perform operations such as use of the virtual item, position management, and position exchange.

Durability: It refers to a usability degree of a virtual item. Generally, when the virtual item, for example, a medicine, a thrown item, or a consumer is used, the durability of the virtual item is reduced. When the durability is reduced to zero, the virtual item is useless or is destroyed.

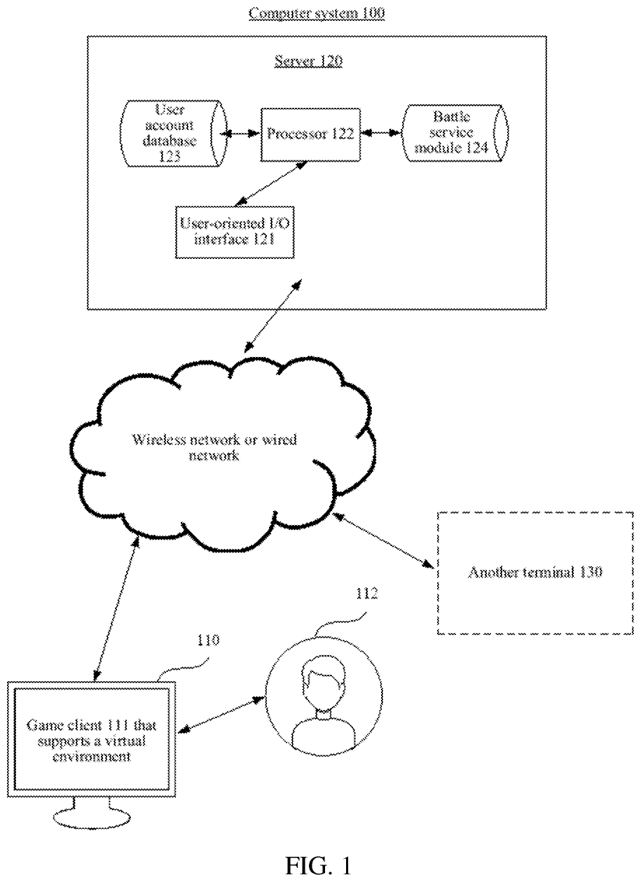

FIG. 1 is a schematic diagram of a computer system 100 according to an aspect of this application. The computer system 100 includes a terminal 110 and a server 120.

A game client 111 that supports a virtual environment is installed and run on the terminal 110. The game client 111 may be a multiplayer online battle program. When the terminal 110 runs the game client 111, a user interface of the game client 111 is displayed on a screen of the terminal 110. In this example, the terminal 110 is a terminal used by a user 112. The game client 111 may be any one of a virtual reality (VR) application, an augmented reality (AR) program, a three-dimensional map program, a virtual reality game, an augmented reality game, a first-person shooting (FPS) game, a third-person shooting (TPS) game, a multiplayer online battle arena (MOBA) game, or a strategy board game. In aspects of this application, terms such as an object, a user, an account, and a player represent same meanings. This is not limited in this application.

The terminal 110 may be generally one of a plurality of terminals. In this example, only the terminal 110 is used as an example for description. Device types of the terminal 110 include at least one of a smart phone, a tablet computer, an e-book reader, a Moving Picture Experts Group Audio Layer III (MP3) player, a Moving Picture Experts Group Audio Layer IV (MP4) player, a portable laptop computer, and a desktop computer.

FIG. 1 shows only one terminal, but in different aspects, there is another terminal 130 to access the server 120. In one example, one or more other terminals 130 are terminals corresponding to a developer. A developing and editing platform for the game client 111 supporting the virtual environment is installed on the other terminals 130. The developer may edit and update the game client 111 on the other terminals 130 and transmit an updated game client installation package to the server 120 through a wireless network or a wired network. The terminal 110 may download the game client installation package from the server 120 to update the game client 111.

The terminal 110 and the other terminals 130 are connected to the server 120 through a wireless network or a wired network.

The server 120 is a network device and includes at least one of a server, a plurality of servers, a cloud computing platform, and a virtualization center. The server 120 is configured to provide a backend service for the game client 111 supporting the virtual environment. In one example, the server 120 undertakes main computing work, and the terminal 110 undertakes secondary computing work. Alternatively, the server 120 undertakes secondary computing work, and the terminal 110 undertakes main computing work. Alternatively, a distributed computing architecture is used between the server 120 and the terminal 110 for collaborative computing.

In one example, the server 120 includes a user-oriented input/output (I/O) interface 121, a processor 122, a user account database 123, and a battle service module 124. The processor 122 is configured to load instructions stored in the server 120 and process data in the user account database 123 and the battle service module 124. The user account database 123 is configured to store data of user accounts used by the terminal 110 and the other terminals 130, for example, avatars of the user accounts, nicknames of the user accounts, battle effectiveness indexes of the user accounts, and service zones of the user accounts. The battle service module 124 is configured to provide a plurality of battle modes for a user to battle, for example, a 1V1 battle mode, a 3V3 battle mode, a 5V5 battle mode, or a battle mode in which one or more users form a camp, then a plurality of (more than three) camps are battled with each other, and ranking and elimination are performed based on a battle result to finally determine a placement. The user-oriented I/O interface 121 is configured to establish communication with the terminal 110 and/or the other terminals 130 through a wireless network or a wired network for data exchange.

A person skilled in the art can know that more or fewer terminals 110 can be provided. For example, only one terminal 110 is provided, dozens or hundreds of terminals 110 are provided, or more terminals are provided. A quantity and device types of terminals 110 are not limited in aspects of this application.

With development of internet technologies and improvement of terminal performance, human-computer interaction operations are developing toward greater convenience, thereby improving user experience. For example, in a game application on a terminal, there are many designs for improving human-computer interaction efficiency. In the related art, in a battle process of a game, a player invokes a wheel control (briefly referred to as a wheel) in a part of a field-of-view picture through interaction with a game application. The wheel is an annular interactive interface in which a virtual item held by the player is displayed. The wheel does not completely block the field of view, yet helps the player quickly use the virtual item. However, content in the wheel displayed in this method needs to be manually set in advance by the player. For example, when the wheel includes eight wheel tabs, virtual items corresponding to the eight wheel tabs at most need to be set in advance. This is excessively time-consuming.

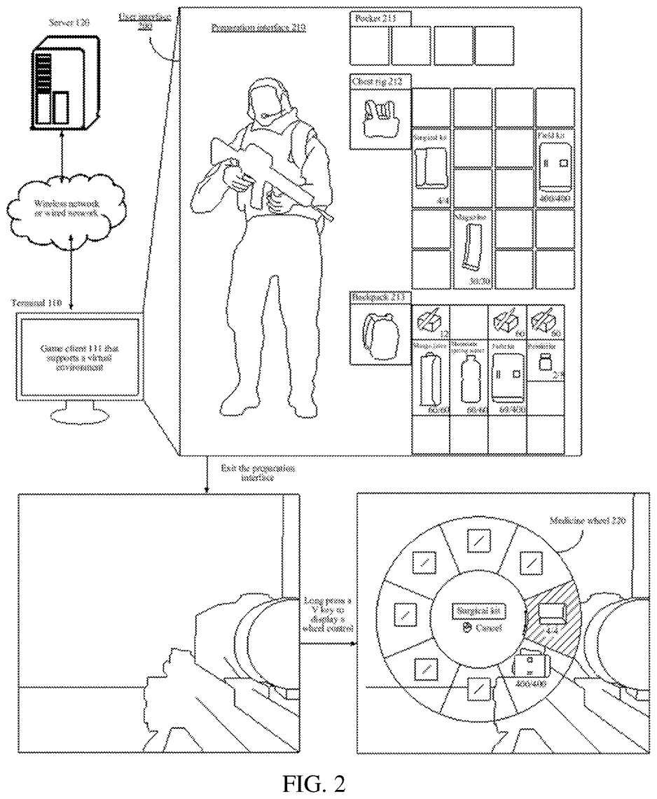

To resolve the foregoing problem, this application provides a wheel display method. FIG. 2 is a schematic diagram of a wheel display method according to an aspect of this application. A terminal 110 exchanges data with a server 120 through a wireless network or a wired network. A game client 111 that supports a virtual environment is installed and run on the terminal 110. When the terminal 110 runs the game client 111, a user interface, for example, a user interface 200, of the game client 111 is displayed on a screen of the terminal 110. In aspects of this application, terms such as an object, a user, an account, a player, a virtual character, and a character represent same meanings, and are configured for representing images controlled in a game. This is not limited in this application.

In some aspects, a preparation interface 210 is displayed on the user interface 200. The preparation interface 210 includes a plurality of types of virtual items carried by a player-controlled virtual character, and the plurality of types of virtual items each correspond to a sorting sequence.

The preparation interface 210 is an interface configured to view and manage the plurality of types of virtual items carried by the player-controlled virtual character. On the preparation interface 210, a player may view a currently carried virtual item, and perform operations such as use of the virtual item, position management, and position exchange.

In some aspects, the preparation interface 210 includes at least two of the following containers: a first container, a second container, and a third container. A capacity of the first container is smaller than a capacity of the second container, and the capacity of the second container is smaller than a capacity of the third container.

As shown in FIG. 2, an example in which the first container is referred to as a pocket 211, the second container is referred to as a chest rig 212, and the third container is referred to as a backpack 213 is used. The pocket 211 and the chest rig 212 have relatively small capacities, but items therein can be quickly used, that is, displayed in a wheel. The backpack 213 has a relatively large capacity, but items therein cannot be quickly used, that is, are not displayed in the wheel.

For example, the capacity of the pocket 211 is 1*4 for a total of four slots, the capacity of the chest rig 212 is 5*4 for a total of 20 slots, and the capacity of the backpack 213 is 10*4 for a total of 40 slots (where only 4*4 for a total of 16 slots are shown in the figure, and the remaining slots are not shown).

No virtual items are shown in the pocket 211. In the chest rig 212, the following items are sequentially displayed in a sequence from left to right and from top to bottom: a surgical kit with 4/4 durability, a field kit with 400/400 durability, and a magazine with 30/30 durability. In the backpack 213, the following items are sequentially displayed in a sequence from left to right and from top to bottom: a stack of 12 remaining bullets, two stacks of 60 remaining bullets each, mango juice with 60/60 durability, mountain spring water with 60/60 durability, a field kit with 69/400 durability, and a painkiller with 2/8 durability. The durability refers to a usability degree of a virtual item. When the virtual item, for example, a medicine, a thrown item, or a consumer is used, the durability of the virtual item is reduced. When the durability is reduced to zero, the virtual item is useless or is destroyed.

In some aspects, when the preparation interface is exited, that the player-controlled virtual character performs a virtual activity in a virtual environment is displayed.

After the preparation interface is exited, the player controls the player-controlled virtual character to perform another virtual activity in the virtual environment, for example, moving, attacking, or defending. As shown in FIG. 2, the terminal 110 displays that the player-controlled virtual character is moving in the virtual environment while holding a virtual prop.

In some aspects, in response to a first wheel triggering operation, a first wheel control is additionally displayed in a process in which the player-controlled virtual character performs the virtual activity. At least one of the virtual item and an empty wheel tab is displayed on the first wheel control.

An example in which the terminal 110 is a desktop computer, the first wheel triggering operation is long pressing on a “V” key on a keyboard, and the first wheel control is a medicine wheel 220 is used. In response to a long-press operation on the “V” key on the keyboard, the terminal 110 displays the medicine wheel 220. A name of a currently selected virtual item is displayed at a central position of the medicine wheel 220. For example, when the surgical kit is currently selected, “surgical kit” is displayed at the central position of the medicine wheel 220. The medicine wheel 220 includes a plurality of wheel tabs, for example, eight wheel tabs. Each wheel tab displays a virtual item or does not display a virtual item, and a wheel tab that does not display a virtual item is an empty wheel tab.

In some aspects, in response to the first wheel triggering operation, a virtual item that has a first functional use and that is included in the first container and a virtual item that has a first functional use and that is included in the second container are displayed in a sequence.

A sequence in which the virtual items are displayed on the wheel control is related to types of containers in which the virtual items are located. For example, in response to the long-press operation on the “V” key on the keyboard, the terminal 110 first displays, on the wheel control, a virtual item in the pocket 211, then displays a virtual item in the chest rig 212, and does not display a virtual item in the backpack 213.

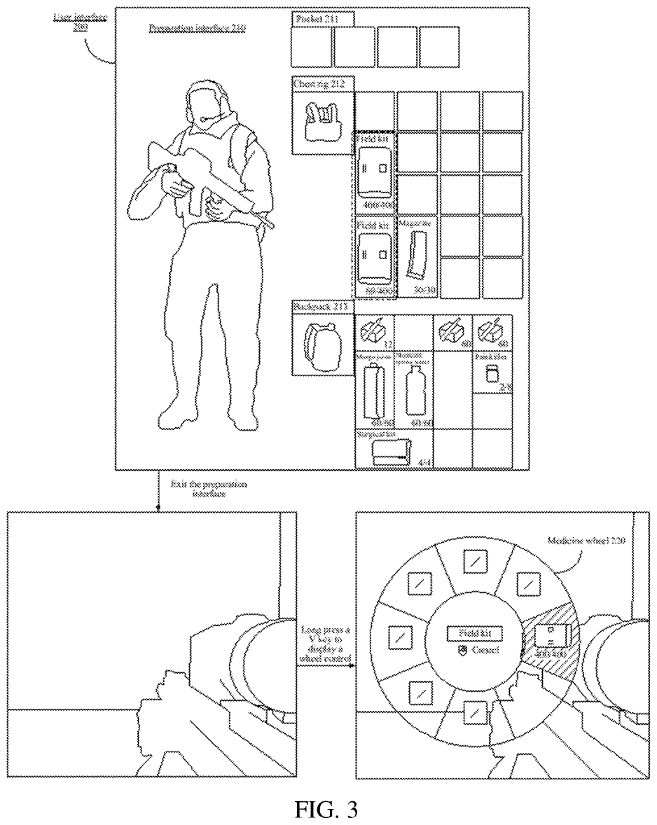

In some aspects, when a plurality of virtual items for the same functional use and different state information exist in the same container, the plurality of virtual items are not simultaneously displayed on the wheel, and only one of the plurality of virtual items is displayed. As shown in FIG. 3, a field kit with 400/400 durability and a field kit with 69/400 durability exist in the chest rig 212, and only one of the field kits is displayed on the wheel, for example, the field kit with 400/400 durability is displayed.

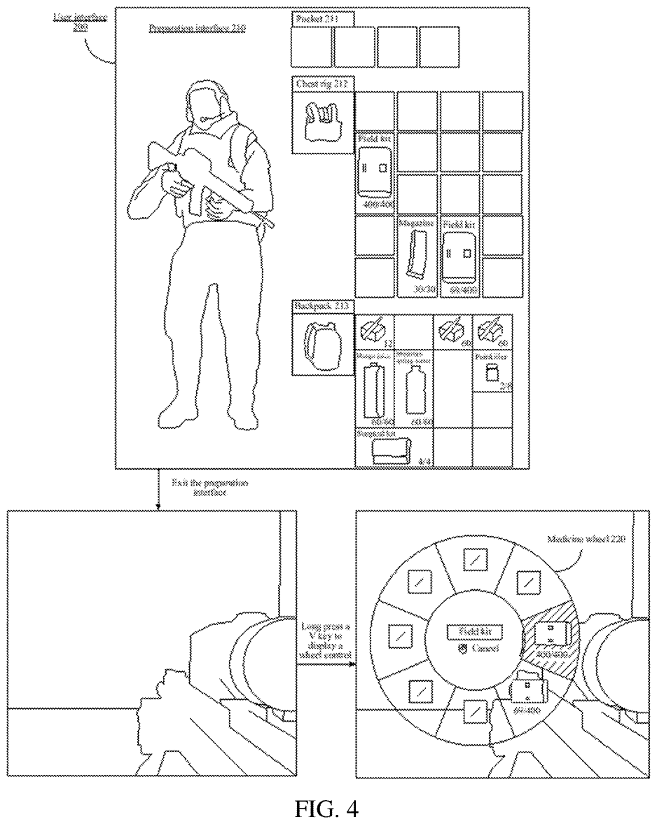

In some other aspects, when a plurality of virtual items for the same functional use and different state information exist in the same container, the plurality of virtual items are simultaneously displayed on the wheel. As shown in FIG. 4, a field kit with 400/400 durability and a field kit with 69/400 durability exist in the chest rig 212, and the two field kits are displayed on the wheel.

In some aspects, at least one type of virtual item is displayed on n wheel tabs surrounding a wheel center in the wheel control. Virtual items of different types and/or virtual items of the same type but different state information are respectively displayed on different wheel tabs of the n wheel tabs.

For example, in FIG. 4, when the wheel control is a medicine wheel 220, virtual items for a treatment-type functional use in the pocket 211 and the chest rig 212 and corresponding state information are displayed. For example, in the pocket 211, there is no virtual item for the treatment-type functional use. In the chest rig 212, two field kits are both virtual items for the treatment-type functional use, and a magazine is not a virtual item for the treatment-type functional use. Therefore, the two field kits are displayed on the medicine wheel, with the first field kit showing 400/400 durability and the second field kit showing 69/400 durability.

For another example, in FIG. 2, when the wheel control is a medicine wheel, virtual items for a treatment-type functional use in the pocket 211 and the chest rig 212 and corresponding state information are displayed. For example, in the pocket 211, there is no virtual item for the treatment-type functional use. In the chest rig 212, a surgical kit and a field kit are both virtual items for the treatment-type functional use, and a magazine is not a virtual item for the treatment-type functional use. Therefore, the field kit and the surgical kit are displayed on the medicine wheel, with the surgical kit showing 4/4 durability and the field kit showing 400/400 durability.

In some aspects, a clockwise display sequence of the at least one type of virtual item on the n wheel tabs is the same as a sorting sequence of the at least one type of virtual item in the preparation interface.

For example, in FIG. 2, a sequence of virtual items displayed on wheel tabs of the wheel control is the same as a sequence obtained by sorting the virtual items in the chest rig 212 in a sorting manner from left to right and from top to bottom. In the chest rig 212, the surgical kit, the field kit, and the magazine are sequentially displayed in a sequence from left to right and from top to bottom, where the surgical kit and the field kit are virtual items for the treatment-type functional use. Therefore, in the medicine wheel 220, starting from a wheel tab at the middle right, the surgical kit and the field kit are displayed clockwise, with the surgical kit showing 4/4 durability and the field kit showing 400/400 durability.

For another example, in FIG. 4, a sequence of virtual items displayed on wheel tabs of the wheel control is the same as a sequence obtained by sorting the virtual items in the chest rig 212 in a sorting manner from left to right and from top to bottom. In the chest rig 212, the field kit with 400/400 durability, the magazine, and the field kit with 69/400 durability are sequentially displayed in a sequence from left to right and from top to bottom, where the field kits are virtual items for the treatment-type functional use. Therefore, in the medicine wheel 220, starting from a wheel tab at the middle right, the field kit with 400/400 durability and the field kit with 69/400 durability are displayed clockwise.

In some aspects, in response to a selection operation on a virtual item on a wheel, a wheel tab corresponding to the virtual item is highlighted.

For example, in FIG. 2, in response to a selection operation on the surgical kit with 4/4 durability, a wheel tab corresponding to the surgical kit is highlighted (where highlighting is represented by a shadow in the figure).

In conclusion, according to the method provided in this example, the at least one type of virtual item is displayed on a plurality of wheel tabs, and the sorting sequence of the at least one type of virtual item in the preparation interface is associated with the display sequence of the at least one type of virtual item on the n wheel tabs. To be specific, the display sequence of the virtual item on the wheel tabs is associated with the sorting sequence of the virtual item in the preparation interface, so that the virtual item can be directly displayed on the plurality of wheel tabs of the wheel control in the associated display sequence in the sorting sequence of the virtual item in the preparation interface. Therefore, there is no need to manually set the virtual item displayed on the wheel tabs in advance, thereby reducing operations, and improving convenience of setting display of the wheel tabs. For example, when there are eight types of different virtual items in the preparation interface, a display sequence of the eight types of different virtual items on eight wheel tabs needs to be manually set, and at least eight operations are needed. According to the method, when there are eight types of different virtual items in the preparation interface, a display sequence of the eight types of different virtual items on eight wheel tabs can be automatically set in a sorting sequence of the eight types of different virtual items in the preparation interface, and no additional operation is needed, thereby improving human-computer interaction efficiency.

According to the method provided in this example, the at least one type of virtual item and corresponding state information are further displayed on the plurality of wheel tabs, and virtual items of the same type but different state information are all displayed on the wheel tabs, so that the virtual item and the corresponding state information can be learned of without opening the preparation interface, thereby improving human-computer interaction efficiency.

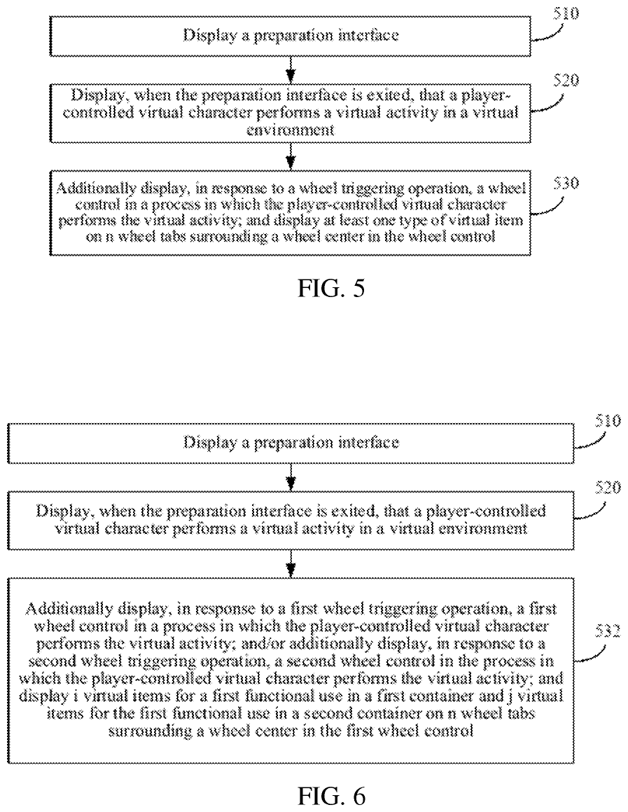

FIG. 5 is a flowchart of a wheel display method according to an aspect of this application. The method includes at least one of the following operations.

Operation 510. Display a preparation interface.

The preparation interface includes at least two types of virtual items carried by a player-controlled virtual character, and the at least two types of virtual items each correspond to a sorting sequence.

The preparation interface is an interface configured to view and manage the plurality of types of virtual items carried by the player-controlled virtual character. On the preparation interface, a player may view a currently carried virtual item, and perform operations such as use of the virtual item, position management, and position exchange.

During each game battle, the player may open the preparation interface at any time, to adjust a sorting sequence of virtual items in the preparation interface. According to this method, after the player adjusts the sorting sequence of the virtual items in the preparation interface, a terminal device automatically adjusts a sorting sequence of the virtual items in another interface associated with the preparation interface, for example, automatically adjusts a sorting sequence of the virtual items in a wheel control, so that the player does not need to manually adjust the sorting sequence of the virtual items in the wheel control. In addition, the sorting sequence of the virtual items in the wheel control can also be set in the sorting sequence of the virtual items in the preparation interface that is customized by the player, to meet a customization requirement of the player.

The sorting sequence is a sequence obtained in a sorting manner. For example, in FIG. 2, virtual items in a chest rig 212 are sorted in a sorting manner from left to right and from top to bottom. The first virtual item is a surgical kit, the second virtual item is a field kit, and the third virtual item is a magazine.

If the sorting manner varies, an obtained sorting sequence also varies. It is assumed that in FIG. 2, the virtual items in the chest rig 212 are sorted in a sorting manner from right to left and from top to bottom. The first virtual item is the field kit, the second virtual item is the surgical kit, and the third virtual item is the magazine.

In some aspects, a capacity is represented by a quantity of slots in the preparation interface, and the virtual item is represented as occupying the slot to indicate that the virtual item is carried by the player-controlled virtual character.

As shown in FIG. 2, the preparation interface 210 includes a pocket 211, a chest rig 212, and a backpack 213. A capacity of the pocket 211 is 1*4 for a total of four slots, a capacity of the chest rig 212 is 5*4 for a total of 20 slots, and a capacity of the backpack 213 is 10*4 for a total of 40 slots (where only 4*4 for a total of 16 slots are shown in the figure, and the remaining slots are not shown).

No virtual items are shown in the pocket 211. In the chest rig 212, the following items are sequentially displayed in a sequence from left to right and from top to bottom: a surgical kit with 4/4 durability, a field kit with 400/400 durability, and a magazine with 30/30 durability. In the backpack 213, the following items are sequentially displayed in a sequence from left to right and from top to bottom: a stack of 12 remaining bullets, two stacks of 60 remaining bullets each, mango juice with 60/60 durability, mountain spring water with 60/60 durability, a field kit with 69/400 durability, and a painkiller with 2/8 durability. The durability refers to a usability degree of a virtual item. When the virtual item, for example, a medicine, a thrown item, or a consumer is used, the durability of the virtual item is reduced. When the durability is reduced to zero, the virtual item is useless or is destroyed.

Operation 520. Display, when the preparation interface is exited, that the player-controlled virtual character performs a virtual activity in a virtual environment.

After the preparation interface is exited, in response to a control operation of the player on the player-controlled virtual character, the terminal device controls the player-controlled virtual character to perform another virtual activity in the virtual environment, for example, moving, attacking, or defending. In aspects of this application, terms such as an object, a user, an account, a player, a virtual character, and a player-controlled virtual character represent same meanings, and are configured for representing images controlled in a game. This is not limited in this application.

Operation 530. Additionally display, in response to a wheel triggering operation, a wheel control in a process in which the player-controlled virtual character performs the virtual activity; and display at least one type of virtual item on n wheel tabs surrounding a wheel center in the wheel control.

In some aspects, a layer on which the wheel control is located covers a layer on which the virtual environment is located. In one example, the terminal device obtains an image of the virtual environment viewed from a perspective of the player-controlled virtual character, that is, an environment image, and obtains an interaction control (including the wheel control) configured to interact with the player, that is, an interface interaction element, to superimpose and display a layer on which the interface interaction element is located above a layer on which the environment image is located, to obtain a user interface. The wheel control is displayed on an upper layer of the environment image in the user interface.

For example, after the wheel control is additionally displayed, the wheel control is displayed at a center of the user interface, and covers a part of the virtual environment. Alternatively, the wheel control is semi-transparent, and therefore causes less occlusion of the virtual environment.

In some aspects, a display sequence of the at least one type of virtual item on the n wheel tabs is related to a sorting sequence of the at least one type of virtual item in the preparation interface, and n is a positive integer greater than 1. The wheel tab may be also referred to as a tab.

The display sequence of the at least one type of virtual item on the n wheel tabs is consistent with the sorting sequence of the at least one type of virtual item in the preparation interface. The display sequence and the sorting sequence are sequential. The terminal device first determines the sorting sequence of the at least one type of virtual item in the preparation interface, and then determines the display sequence of the at least one type of virtual item on the n wheel tabs. For example, the at least one type of virtual item includes a virtual item A, a virtual item B, and a virtual item C. In the preparation interface, the virtual item A is displayed first, the virtual item B is displayed second, and the virtual item C is displayed third. On the wheel tabs, the virtual item A is displayed first, the virtual item C is displayed second, and the virtual item B is not displayed because the virtual item B does not satisfy a condition for being displayed on the wheel tab. However, for both the virtual item A and the virtual item C, the virtual item C is displayed after the virtual item A.

As shown in FIG. 2, in the preparation interface, in a sequence from left to right and from top to bottom, the surgical kit is the first virtual item, and the field kit is the second virtual item. Therefore, in the medicine wheel 220, starting from a tab at the middle right, a clockwise direction is used as a display sequence, the surgical kit is the first displayed virtual item, and the field kit is the second displayed virtual item.

In conclusion, according to the method provided in this example, the at least one type of virtual item is displayed on a plurality of wheel tabs, and the sorting sequence of the at least one type of virtual item in the preparation interface is associated with the display sequence of the at least one type of virtual item on the n wheel tabs. To be specific, the display sequence of the virtual item on the wheel tabs is associated with the sorting sequence of the virtual item in the preparation interface, so that the virtual item can be directly displayed on the plurality of wheel tabs of the wheel control in the associated display sequence in the sorting sequence of the virtual item in the preparation interface. Therefore, there is no need to manually set the virtual item displayed on the wheel tabs in advance, thereby reducing operations, and improving convenience of setting display of the wheel tabs. For example, when there are eight types of different virtual items in the preparation interface, a display sequence of the eight types of different virtual items on eight wheel tabs needs to be manually set, and at least eight operations are needed. According to the method, when there are eight types of different virtual items in the preparation interface, a display sequence of the eight types of different virtual items on eight wheel tabs can be automatically set in a sorting sequence of the eight types of different virtual items in the preparation interface, and no additional operation is needed, thereby improving human-computer interaction efficiency.

FIG. 6 is a flowchart of a wheel display method according to an aspect of this application. The method includes at least one of the following operations.

Operation 510. Display a preparation interface.

In some aspects, the preparation interface 210 includes at least two of the following containers: a first container, a second container, and a third container. A capacity of the first container is smaller than a capacity of the second container, and the capacity of the second container is smaller than a capacity of the third container.

As shown in FIG. 2, an example in which the first container is referred to as a pocket 211, the second container is referred to as a chest rig 212, and the third container is referred to as a backpack 213 is used. The pocket 211 and the chest rig 212 have relatively small capacities, but items therein can be quickly used, that is, displayed in a wheel control. The backpack 213 has a relatively large capacity, but items therein cannot be quickly used, that is, are not displayed in the wheel control.

Operation 520. Display, when the preparation interface is exited, that a player-controlled virtual character performs a virtual activity in a virtual environment.

In some aspects, operation 520 may be omitted. To be specific, without exiting the preparation interface, an operation following operation 510 is: additionally displaying, in response to a wheel triggering operation, a wheel control on the preparation interface, and displaying at least one type of virtual item on n wheel tabs surrounding a wheel center in the wheel control.

For specific implementation details of subsequent operations, refer to operation 532 or another example. Details are not described herein.

Operation 532. Additionally display, in response to a first wheel triggering operation, a first wheel control in the process in which the player-controlled virtual character performs the virtual activity; and/or additionally display, in response to a second wheel triggering operation, a second wheel control in the process in which the player-controlled virtual character performs the virtual activity; and display i virtual items for the first functional use in the first container and j virtual items for the first functional use in the second container on n wheel tabs surrounding a wheel center in the first wheel control.

The preparation interface is configured to display a plurality of types of virtual items in at least two containers, and the at least two containers include at least two of the following: a first container, a second container, and a third container. A virtual item for a first functional use is displayed on the first wheel control, and a virtual item for a second functional use is displayed on the second wheel control, i and j are positive integers, i is less than or equal to n, and j is less than or equal to n−i.

Different wheel triggering operations correspond to different wheel controls:

In some aspects, in response to different wheel triggering operations, a terminal device separately additionally displays different wheel controls in the process in which the player-controlled virtual character performs the virtual activity.

For example, in response to long pressing on a “V” key, the terminal device additionally displays a medicine wheel control, and a virtual item for a treatment-type functional use is displayed on the medicine wheel control; and/or in response to long pressing on a “G” key, the terminal device additionally displays a thrown item wheel control, and a virtual item for a throw-type functional use is displayed on the thrown item wheel control. There may be another operation method for the wheel triggering operation. This is merely used as an example in this aspect of this application, and specific implementation details are not limited.

In some aspects, a correspondence between the wheel triggering operation and a displayed wheel control is customized.

For example, in response to long pressing on the “V” key, the terminal device additionally displays the medicine wheel control; in response to long pressing on the “G” key, the terminal device additionally displays the medicine wheel control; or in response to clicking/tapping on the “V” key, the terminal device additionally displays the medicine wheel control. The correspondence between the wheel triggering operation and the displayed wheel control may be customized. This is not limited in this aspect of this application.

In some aspects, a functional use of the virtual item includes at least one of the following: a treatment-type functional use, a defense prop-type functional use, an attack prop-type functional use, a throw-type functional use, an auxiliary-type functional use, and a consumption-type functional use.

For example, a surgical kit and a first rescue medicine belong to virtual items for the treatment-type functional use. A helmet and a body armor belong to virtual items for the defense prop-type functional use. A remote attack prop and a short-range attack prop belong to virtual items for the attack prop-type functional use. A hand grenade and a flashbang belong to a virtual item for the throw-type functional use. An aiming scope and a silencer belong to virtual items for the auxiliary-type functional use. Various types of ammunitions are virtual items for the consumption-type functional use. There may be another classification method for the foregoing functional uses. This is merely used as an example in this aspect of this application, and specific implementation details are not limited.

The wheel triggering operation is associated with the displayed wheel control, so that different wheel controls can be triggered and displayed during a battle by a player based on current requirements for using virtual items for different functional uses, to select and use a corresponding virtual item, thereby improving item display and selection efficiency.

Virtual item display sequence:

In some aspects, a clockwise display sequence of the at least one type of virtual item on the n wheel tabs is the same as a sorting sequence of the at least one type of virtual item in the preparation interface.

In some other aspects, an anticlockwise display sequence of the at least one type of virtual item on the n wheel tabs is the same as the sorting sequence of the at least one type of virtual item in the preparation interface,
a starting tab for displaying the at least one type of virtual item being a first tab of the wheel control, and the first tab being a preset wheel tab in the n wheel tabs.

For example, the first tab is preset to be a tab at the middle right, a tab at the middle left, a tab at the top center, or a tab at the bottom center, or another wheel tab in the n wheel tabs. In this aspect of this application, an example in which the first tab is the tab at the middle right is usually used for description.

In some aspects, a display sequence of the at least one type of virtual item on the n wheel tabs is the same as a sorting sequence of the at least one type of virtual item in the preparation interface.

As shown in FIG. 4, a field kit with 400/400 durability and a field kit with 69/400 durability are displayed on a medicine wheel 220. In the preparation interface 210, in a sequence obtained in a sorting manner from left to right and from top to bottom, the field kit with 400/400 durability is displayed first, and then the field kit with 69/400 durability is displayed. Therefore, for a sequence of displaying the two field kits on wheel tabs, the field kit with 400/400 durability is first displayed, and then the field kit with 69/400 durability is displayed. A display direction of the virtual items may be a clockwise direction, or may be an anticlockwise direction. This is not limited in this aspect of this application, and usually, the clockwise direction is used as an example for illustration.

In some aspects, a quantity of the at least two types of virtual items is greater than or equal to n, the at least one type of virtual item includes first n virtual items in the at least two types of virtual items, a clockwise display sequence of the first n virtual items on the n wheel tabs is the same as a sorting sequence of the first n virtual items in the preparation interface, and the first n virtual items are determined in the sorting sequence of the at least two types of virtual items in the preparation interface.

In some other aspects, a quantity of the at least two types of virtual items is greater than or equal to n, the at least one type of virtual item includes first n virtual items in the at least two types of virtual items, an anticlockwise display sequence of the first n virtual items on the n wheel tabs is the same as a sorting sequence of the first n virtual items in the preparation interface, and the first n virtual items are determined in the sorting sequence of the at least two types of virtual items in the preparation interface.

In some aspects, a quantity of the at least two types of virtual items is k, the at least one type of virtual item includes k virtual items, a clockwise display sequence of the k virtual items on k wheel tabs is the same as a sorting sequence of the k virtual items in the preparation interface, and k is a positive integer less than n.

In some other aspects, a quantity of the at least two types of virtual items is k, the at least one type of virtual item includes k virtual items, an anticlockwise display sequence of the k virtual items on k wheel tabs is the same as a sorting sequence of the k virtual items in the preparation interface, and k is a positive integer less than n.

In some aspects, a quantity of the at least two types of virtual items is p, the at least one type of virtual item includes p virtual items, a clockwise display sequence of the p virtual items on q wheel tabs is related to a sorting sequence of the p virtual items in the preparation interface, identical virtual items in the p virtual items are combined into the same wheel tab, p and q are positive integers less than n, and p is greater than q.

In some other aspects, a quantity of the at least two types of virtual items is p, the at least one type of virtual item includes p virtual items, an anticlockwise display sequence of the p virtual items on q wheel tabs is related to a sorting sequence of the p virtual items in the preparation interface, identical virtual items in the p virtual items are combined into the same wheel tab, p and q are positive integers less than n, and p is greater than q.

In one example, when a quantity of virtual items displayed in the wheel control is less than a quantity of wheel tabs, that is, less than n, a wheel tab on which no virtual item is displayed is in an empty state.

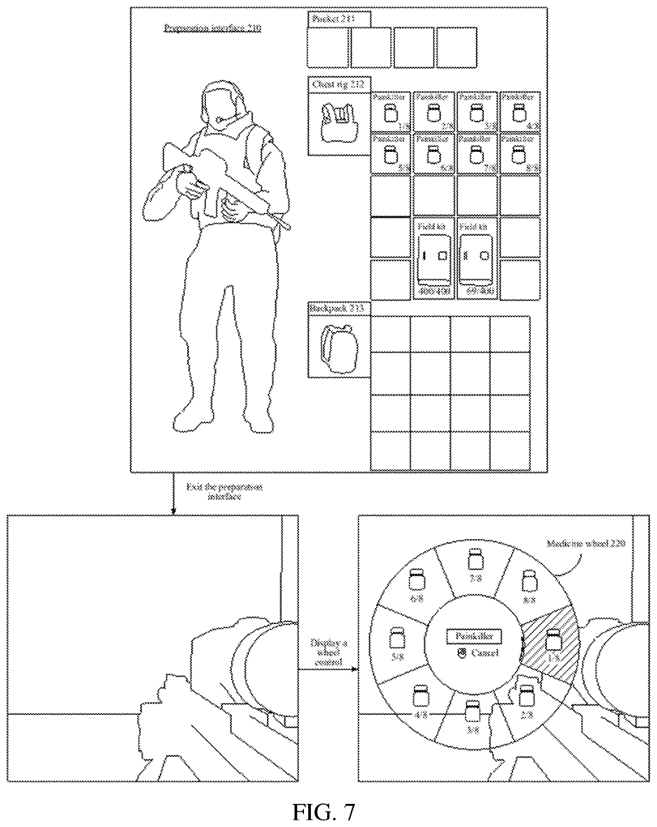

For example, as shown in FIG. 7, n is 8, and there are 10 virtual items in total in the preparation interface, including eight painkillers with durability ranging from 1/8 to 8/8, a field kit with 400/400 durability, and a field kit with 69/400 durability. First eight virtual items in the 10 virtual items are the eight painkillers with durability ranging from 1/8 to 8/8, the eight painkillers are displayed clockwise on eight wheel tabs. The field kit with 400/400 durability and the field kit with 69/400 durability are not displayed on the wheel tabs. A clockwise display sequence of the eight painkillers on the eight wheel tabs is the same as a sorting sequence of the eight painkillers in the preparation interface.

Alternatively, k is 2, and a clockwise display sequence of two virtual items on two wheel tabs is the same as a sorting sequence of the two virtual items in the preparation interface. As shown in FIG. 2, a clockwise display sequence of the two virtual items, namely, the surgical kit and the field kit, on the two wheel tabs is displaying the surgical kit first and then displaying the field kit, which is the same as the sorting sequence of the two virtual items in the preparation interface. The sorting sequence is a sequence obtained in a sorting manner from left to right and from top to bottom in the preparation interface.

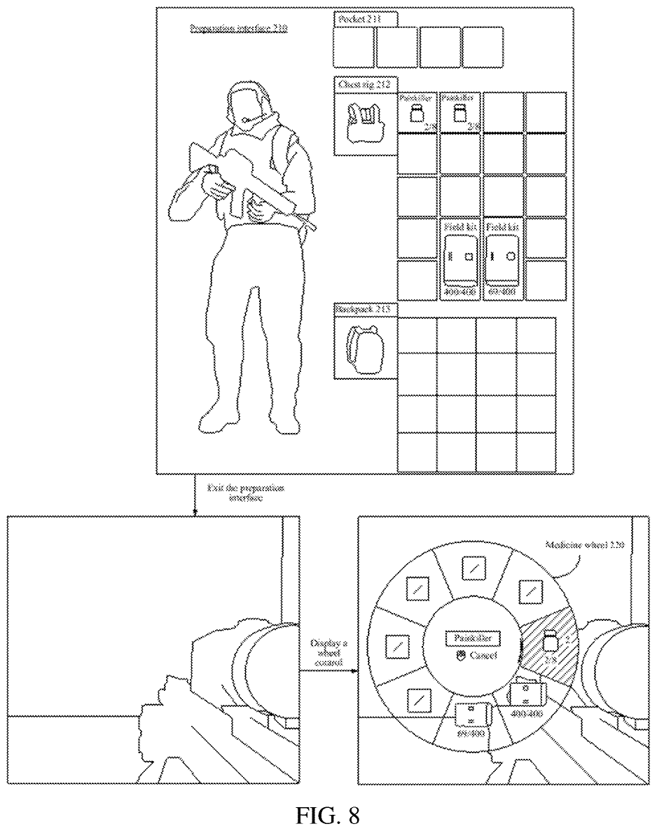

Alternatively, as shown in FIG. 8, p is 4, q is 3, and the at least one type of virtual item includes four virtual items, specifically including: two painkillers with 2/8 durability, one field kit with 400/400 durability, and one field kit with 69/400 durability. The painkillers with 2/8 durability, the field kit with 400/400 durability, and the field kit with 69/400 durability are displayed clockwise on three wheel tabs, and there are two remaining painkillers with 2/8 durability displayed on the right of the painkiller. In the preparation interface 210, the two painkillers with 2/8 durability are first displayed, then the field kit with 400/400 durability is displayed, and finally the field kit with 69/400 durability is displayed. In the medicine wheel 220, the painkillers with 2/8 durability are also first displayed, then the field kit with 400/400 durability is displayed, and finally the field kit with 69/400 durability is displayed.

In one example, a plurality of identical virtual items are respectively displayed on a plurality of wheel tabs. For example, the two painkillers with 2/8 durability are respectively displayed on two wheel tabs.

The foregoing display sequence and display quantities of the virtual items on the wheel tabs may be selected and configured by a player based on an operation habit or a requirement of the player via a configuration interface provided for the player.

By way of example and not limitation, the sorting sequence of the at least two types of virtual items in the preparation interface includes a sequence obtained by sorting the at least two types of virtual items in a sorting manner from left to right and from top to bottom in the preparation interface.

The sequence obtained in the sorting manner from left to right and from top to bottom is only an example, or may be a sequence obtained in a sorting manner from right to left and from top to bottom, or may be a sequence obtained in a sorting manner from left to right and from bottom to top. A specific sorting manner is not limited in this aspect of this application.

Virtual item displayed on a wheel tab:

In some aspects, virtual items of different types and/or virtual items of the same type but different state information are respectively displayed on different wheel tabs of the n wheel tabs,
the type being configured for distinguishing virtual items of different types, and the state information indicating a current state of the virtual item.

In some aspects, the state information includes at least one of the following: durability, remaining quantity, and remaining time. The durability refers to a usability degree of a virtual item.

As shown in FIG. 2, the terminal device separately displays the two virtual items: the surgical kit and the field kit on the wheel tabs. Alternatively, as shown in FIG. 4, the terminal device separately displays, on the wheel tabs, the two virtual items of the same type but different state information: the field kit with 400/400 durability and the field kit with 69/400 durability.

In one example, virtual items of the same type and same state information are respectively displayed on different wheel tabs of the n wheel tabs.

In some aspects, the preparation interface is configured to display a plurality of types of virtual items in at least two containers, and the at least two containers include at least two of the following: a first container, a second container, and a third container;
a clockwise display sequence of the virtual item for the first functional use in the first container on the n wheel tabs is the same as a sorting sequence of the virtual item for the first functional use in the first container; and
a start tab for displaying the virtual item for the first functional use in the second container is a next wheel tab of an end tab for displaying the virtual item for the first functional use in the first container, and a clockwise display sequence of the virtual item for the first functional use in the second container on the n wheel tabs is the same as a sorting sequence of the virtual item for the first functional use in the second container.

In some aspects, the terminal device displays i virtual items for the first functional use in the first container and j virtual items for the first functional use in the second container on n wheel tabs surrounding a wheel center in the first wheel control, i and j being positive integers, i being less than or equal to n, and j being less than or equal to n−i.

In some aspects, the method further includes: When there is no virtual item for the first functional use in the preparation interface, the terminal device does not display any virtual item on the n wheel tabs of the first wheel control; and/or when there is no virtual item for the second functional use in the preparation interface, the terminal device does not display any virtual item on the n wheel tabs of the second wheel control.

For example, when no virtual item for a treatment-type functional use exists in the preparation interface, the n wheel tabs of the first wheel control are all empty tabs, or the n wheel tabs are all in an empty state, and no virtual item is displayed on the wheel tabs.

In one example, a capacity of the first container is smaller than a capacity of the second container, and the capacity of the second container is smaller than a capacity of the third container. As shown in FIG. 2, an example in which the first container is referred to as a pocket 211, the second container is referred to as a chest rig 212, and the third container is referred to as a backpack 213 is used. The pocket 211 and the chest rig 212 have relatively small capacities, but items therein can be quickly used, that is, displayed in a wheel. The backpack 213 has a relatively large capacity, but items therein cannot be quickly used, that is, are not displayed in the wheel.

For example, the capacity of the pocket 211 is 1*4 for a total of four slots, the capacity of the chest rig 212 is 5*4 for a total of 20 slots, and the capacity of the backpack 213 is 10*4 for a total of 40 slots (where only 4*4 for a total of 16 slots are shown in the figure, and the remaining slots are not shown).

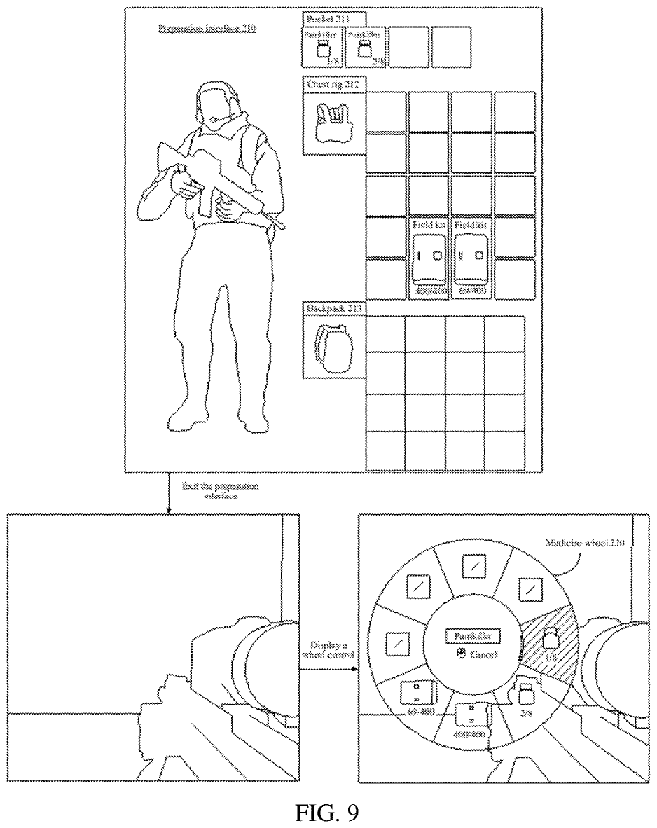

For example, in FIG. 9, it is assumed that the first functional use is the treatment-type functional use, and a painkiller in the pocket 211 and a field kit in the chest rig 212 are both virtual items for the treatment-type functional use. In the pocket 211, there are two virtual items for the treatment-type functional use, and a painkiller with 1/8 durability and a painkiller with 2/8 durability are sequentially displayed in a sequence from left to right. In the chest rig 212, there are two virtual items for the treatment-type functional use, and a field kit with 400/400 durability and a field kit with 69/400 durability are sequentially displayed in a sequence from left to right and from top to bottom.

Starting from a wheel tab at the middle right of the medicine wheel 220, the painkiller with 1/8 durability is displayed on the first wheel tab, and a painkiller with 2/8 durability is displayed on the second wheel tab. The third wheel tab is a start tab configured to display the virtual item for the treatment-type functional use in the chest rig 212, and is configured to display the field kit with 400/400 durability. The fourth wheel tab is configured to display the field kit with 69/400 durability. In the same sorting sequence as that in the chest rig 212, the field kit with 400/400 durability is first displayed, and then the field kit with 69/400 durability is displayed.

In conclusion, according to the method provided in this example, the at least one type of virtual item is displayed on a plurality of wheel tabs, and the sorting sequence of the at least one type of virtual item in the preparation interface is associated with the display sequence of the at least one type of virtual item on the n wheel tabs. To be specific, the display sequence of the virtual item on the wheel tabs is associated with the sorting sequence of the virtual item in the preparation interface, so that the virtual item can be directly displayed on the plurality of wheel tabs of the wheel control in the associated display sequence in the sorting sequence of the virtual item in the preparation interface. Therefore, there is no need to manually set the virtual item displayed on the wheel tabs in advance, thereby reducing operations, and improving convenience of setting display of the wheel tabs. For example, when there are eight types of different virtual items in a preparation interface, a display sequence of the eight types of different virtual items on eight wheel tabs needs to be manually set, and at least eight operations are needed. According to the method, when there are eight types of different virtual items in the preparation interface, a display sequence of the eight types of different virtual items on eight wheel tabs can be automatically set in a sorting sequence of the eight types of different virtual items in the preparation interface, and no additional operation is needed, thereby improving human-computer interaction efficiency.

According to the method provided in this example, the at least one type of virtual item and corresponding state information are further displayed on the plurality of wheel tabs, and virtual items of the same type but different state information are all displayed on the wheel tabs, so that the virtual item and the corresponding state information can be learned of without opening the preparation interface, thereby improving selection and use efficiency of the virtual item displayed on the wheel tab, and improving human-computer interaction efficiency.

According to the method provided in this example, when the preparation interface includes a plurality of containers, for example, the first container, the second container, and the third container, a virtual item in the first container is first displayed on the n wheel tabs, and then a virtual item in the second container is displayed, so that the player can place a virtual item that needs to be quickly used in the first container, and can select the virtual item quickly when the player needs to use the virtual item, without spending excessively much time on selecting the virtual item, thereby improving human-computer interaction efficiency.

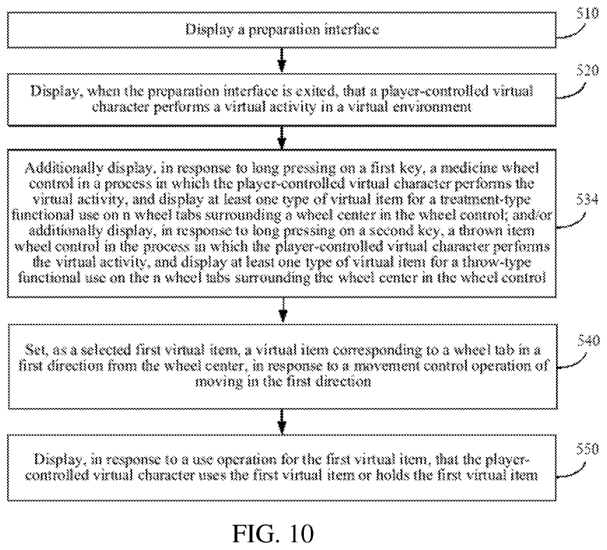

FIG. 10 is a flowchart of a wheel display method according to an aspect of this application. The method includes at least one of the following operations.

Operation 510. Display a preparation interface.

Operation 520. Display, when the preparation interface is exited, that a player-controlled virtual character performs a virtual activity in a virtual environment.

Operation 534. Additionally display, in response to long pressing on a first key, a medicine wheel control in the process in which the player-controlled virtual character performs the virtual activity; and display at least one type of virtual item for a treatment-type functional use on n wheel tabs surrounding a wheel center in the wheel control; and/or
additionally display, in response to long pressing on a second key, a thrown item wheel control in the process in which the player-controlled virtual character performs the virtual activity; and display at least one type of virtual item for a throw-type functional use on the n wheel tabs surrounding the wheel center in the wheel control.

In some aspects, the method is implemented in a scenario in which external devices are a mouse and a keyboard. For example, the first key and the second key are respectively two keys on the keyboard, for example, respectively a “V” key and a “G” key.

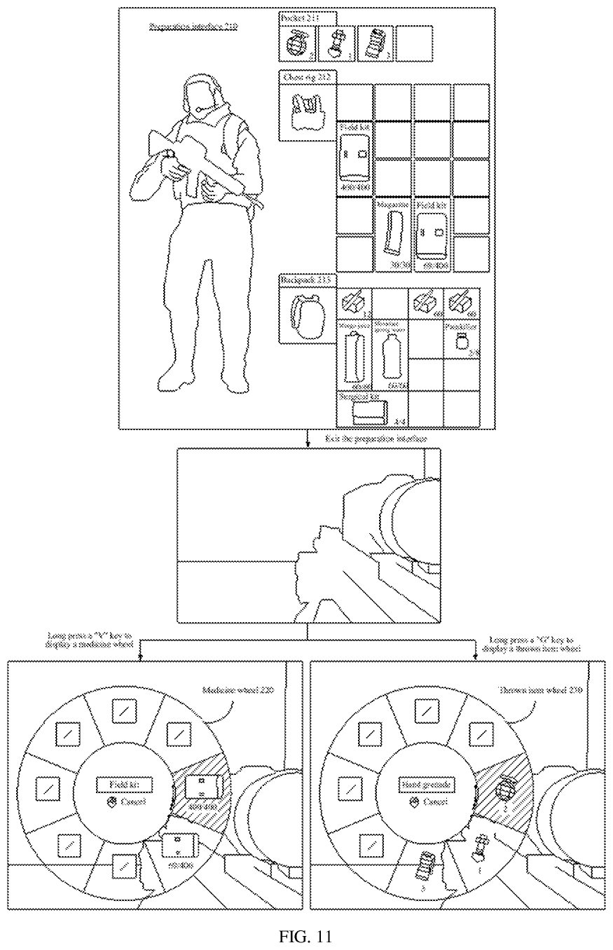

As shown in FIG. 11, in a preparation interface 210, in a pocket 211, the following items are displayed in a sequence from left to right: two remaining hand grenades, one remaining flashbang, and three remaining smoke grenades. In the chest rig 212, the following items are sequentially displayed in a sequence from left to right and from top to bottom: a field kit with 400/400 durability, a magazine with 30/30 durability, and a field kit with 69/400 durability. In the backpack 213, the following items are sequentially displayed in a sequence from left to right and from top to bottom: a stack of 12 remaining bullets, two stacks of 60 remaining bullets each, mango juice with 60/60 durability, mountain spring water with 60/60 durability, a painkiller with 2/8 durability, and a surgical kit with 4/4 durability.

For example, in response to long pressing on the “V” key, a terminal device additionally displays a medicine wheel control 220. Only the field kit with 400/400 durability and the field kit with 69/400 durability in the pocket 211 and the chest rig 212 are virtual items for the treatment-type functional use, and in a sequence from left to right and from top to bottom, the field kit with 400/400 durability is displayed first, and then the field kit with 69/400 durability is displayed. Therefore, on two wheel tabs of the medicine wheel 220, starting from a wheel tab at the middle right, the terminal device first displays the field kit with 400/400 durability, followed clockwise by the field kit with 69/400 durability.

In response to long pressing on the “G” key, the terminal device displays a thrown item wheel 230. The hand grenade, the flashbang, and the smoke grenade in the pocket 211 are virtual items for the throw-type functional use. Therefore, in the thrown item wheel 230, starting from a wheel tab at the middle right, the terminal device sequentially displays, clockwise, the two remaining hand grenades, the one remaining flashbang, and the three remaining smoke grenades.

Virtual items for different functional uses are only displayed on corresponding wheel controls. If a functional use does not correspond to a wheel control, a virtual item is not displayed on that non-corresponding wheel control, even if the virtual item is positioned earlier in the sequence. For example, although the hand grenade is positioned earlier in the sequence compared to the field kit, the hand grenade is not displayed on the medicine wheel 220.

In one example, in response to single clicking/tapping on the first key, the terminal device displays the medicine wheel control, and displays the at least one type of virtual item for the treatment-type functional use on the n wheel tabs surrounding the wheel center in the wheel control; and/or in response to single clicking/tapping on the second key, the terminal device displays the thrown item wheel control, and displays the at least one type of virtual item for the throw-type functional use on the n wheel tabs surrounding the wheel center in the wheel control.

In one example, in response to simultaneous pressing on a first key group, the terminal device displays the medicine wheel control, and displays the at least one type of virtual item for the treatment-type functional use on the n wheel tabs surrounding the wheel center in the wheel control. The first key group includes the first key and at least one other key.

In one example, in response to simultaneous pressing on a second key group, the terminal device displays the thrown item wheel control, and displays the at least one type of virtual item for the throw-type functional use on the n wheel tabs surrounding the wheel center in the wheel control. The second key group includes the second key and at least one other key.

An interaction operation for displaying the wheel control may include other possible operations. The foregoing interaction operation is merely used as an example, and is not limited in this aspect of this application.

In some aspects, after the first key is long-pressed, the first key is released, and the medicine wheel control disappears; and/or after the second key is long-pressed, the second key is released, and the thrown item wheel control disappears.

In some aspects, the method further includes: In response to a selection operation on a virtual item on the wheel control, the terminal device highlights a wheel tab corresponding to the virtual item.

For example, in FIG. 11, in response to a selection operation on the field kit with 400/400 durability, a wheel tab corresponding to the field kit is highlighted (where highlighting is represented by a shadow in the figure). In response to a selection operation on the two remaining hand grenades, a wheel tab corresponding to the hand grenades is highlighted, that is, the highlighted wheel tab represents a selected wheel tab.

In one example, after the player selects a virtual item A from the medicine wheel control, if the selected virtual item A cannot be used, prompt text, such as “The virtual item A cannot be used”, appears. If the selected virtual item A can be used, the virtual item A is directly used.

After the player selects a virtual item B on the thrown item wheel control, the virtual item B is displayed in a hand of a player-controlled virtual character. If the player-controlled virtual character already has a virtual item of the same type as the virtual item B in the hand, there is no change (where for example, if the player-controlled virtual character originally holds the virtual item B and then the virtual item B is selected, nothing happens). If the player-controlled virtual character does not hold a virtual item in the hand, or holds a virtual item of a different type from the virtual item B, the virtual item B is displayed in the hand of the player-controlled virtual character.

In some aspects, the method further includes: closing the wheel control in response to a right-clicking operation on a mouse.

In one example, a dragging operation on the mouse after the wheel control is opened does not affect an orientation of a visual angle of the player-controlled virtual character.

After the wheel control is opened, no matter which direction the mouse is dragged, the orientation of the visual angle of the player-controlled virtual character is not changed, and the orientation of the visual angle of the player-controlled virtual character keeps the orientation of the visual angle before the wheel control is opened.

Operation 540. Set, as a selected first virtual item, a virtual item corresponding to a wheel tab located in a first direction, starting from the wheel center, in response to a movement control operation moving in the first direction,
the first direction including at least one of the following directions: top center, top right, middle right, bottom right, bottom center, bottom left, middle left, and top left.

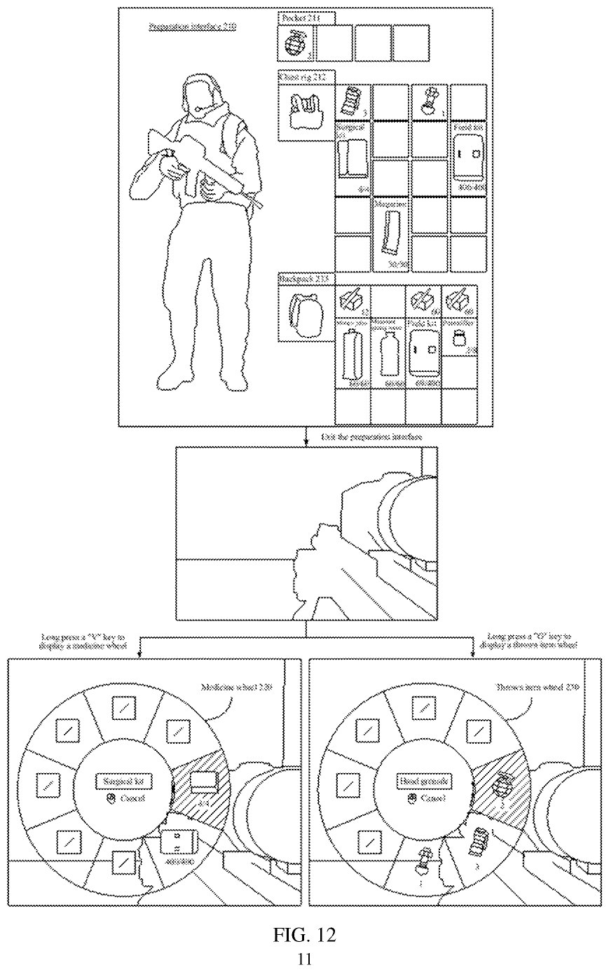

An example in which the method is implemented in a scenario in which external devices are a mouse and a keyboard is used. For example, in response to an operation of moving the mouse toward the middle right, the terminal device sets, as the selected first virtual item, a virtual item corresponding to a wheel tab at the middle right, starting from the wheel center. As shown in FIG. 12, for the medicine wheel 220, the mouse is moved toward the middle right, and the terminal device sets the surgical kit with 4/4 durability as the selected first virtual item.

In some aspects, an icon corresponding to the mouse is not displayed when the wheel control is displayed.

The icon corresponding to the mouse is not displayed, but a wheel tab corresponding to a current position of the mouse is highlighted, to indicate the currently selected wheel tab. For example, when the mouse is moved onto the wheel tab at the middle right, the wheel tab at the middle right is highlighted. Alternatively, when the mouse is moved on the top center of a game interface, the top center of the game interface corresponds to a wheel tab at the top center, and therefore the wheel tab at the top center is highlighted.

Operation 550. Display, in response to a use operation for the first virtual item, that the player-controlled virtual character uses the first virtual item or holds the first virtual item.

In some aspects, in response to an operation of clicking/tapping the first key for the first virtual item, the terminal device displays that the player-controlled virtual character uses the first virtual item or holds the first virtual item.

In some other aspects, in response to an operation of releasing a key that is being long-pressed for the first virtual item, the terminal device displays that the player-controlled virtual character uses the first virtual item or holds the first virtual item, the key that is being long-pressed being a key corresponding to the wheel triggering operation.

Clicking/Tapping the first key and releasing the key that is being long-pressed are merely two examples of use operations, which are not limited in this aspect of this application.

In some aspects, the first virtual item is a virtual item for the treatment-type functional use, and in response to a use operation for the first virtual item, the terminal device displays that the player-controlled virtual character uses the first virtual item.

In some other aspects, the first virtual item is a virtual item for the throw-type functional use, and in response to a use operation for the first virtual item, the terminal device displays that the player-controlled virtual character holds the first virtual item.

Virtual items for different functional uses correspond to different operations of the player-controlled virtual character. For example, when the first virtual item is a medicine, in response to a use operation for the first virtual item, the terminal device displays that the player-controlled virtual character continuously uses the medicine. For another example, when the first virtual item is a hand grenade, in response to a use operation for the first virtual item, the terminal device displays that the player-controlled virtual character holds the hand grenade.

An example in which the method is implemented in a scenario in which external devices are a mouse and a keyboard is used, and the first key is a left mouse button or any key on the keyboard, for example, a “Y” key. It is assumed that the method is applied to a handle scenario, and the first key is any key on the handle, for example, a confirmation key. This is not limited in this aspect of this application.

For example, in response to performing an operation of clicking a left mouse button for the virtual item for the treatment-type functional use, the terminal device displays that the player-controlled virtual character continuously uses the virtual item for the treatment-type functional use.

In some aspects, the method further includes: In a period in which the player-controlled virtual character continuously uses the first virtual item, in response to a clicking/tapping operation on the second key, the terminal device displays that the player-controlled virtual character interrupts use of the first virtual item.

An example in which the method is implemented in a scenario in which external devices are a mouse and a keyboard is used, and the second key is a right mouse button or any key on the keyboard, for example, an “N” key. It is assumed that the method is applied to a handle scenario, and the second key is any key on the handle, for example, a cancel key. This is not limited in this aspect of this application.

For example, in a period in which the player-controlled virtual character continuously uses the virtual item for the treatment-type functional use, in response to a clicking operation on the right mouse button, the terminal device displays that the player-controlled virtual character interrupts use of the virtual item for the treatment-type functional use.

In some aspects, the method further includes: In a period in which the player-controlled virtual character holds the first virtual item, in response to a long-press operation on the first key, the terminal device displays that the player-controlled virtual character prepares to throw the first virtual item, and in response to a releasing operation on the first key, the terminal device displays that the player-controlled virtual character throws the first virtual item at a first height.

In response to a long-press operation on the second key, the terminal device displays that the player-controlled virtual character prepares to throw the first virtual item, and in response to a releasing operation on the second key, the terminal device displays that the player-controlled virtual character throws the first virtual item at a second height, the second height being lower than the first height.

For example, an example in which the first key is the left mouse button, the second key is the right mouse button, and the first virtual item is a hand grenade in the virtual item for the throw-type functional use is used. In a period in which the player-controlled virtual character holds the hand grenade, in response to a long-press operation on the left mouse button, the terminal device displays that the player-controlled virtual character pulls a pull ring of the hand grenade, to prepare to throw the hand grenade. In response to a releasing operation on the left mouse button, the terminal device displays that the player-controlled virtual character throws the hand grenade at the first height.

In response to a long-press operation on the right mouse button, the terminal device displays that the player-controlled virtual character pulls a pull ring of the hand grenade, to prepare to throw the hand grenade. In response to a releasing operation on the right mouse button, the terminal device displays that the player-controlled virtual character throws the hand grenade at the second height. The second height is lower than the first height.

In some aspects, the method further includes: In a period in which the player-controlled virtual character holds the first virtual item, in response to an operation of switching the first virtual item currently held, the terminal device displays that the player-controlled virtual character holds another virtual item.

For example, in a period in which the player-controlled virtual character holds a hand grenade, or pulls a pull ring of the hand grenade but has not thrown the hand grenade, in response to switching the currently held hand grenade to a smoke grenade, the terminal device displays that the player-controlled virtual character holds the smoke grenade.

In conclusion, according to the method provided in this example, different wheel controls and virtual items in the wheel controls are displayed by using different interaction operations, and a virtual item needed by the player is displayed based on different scenarios. For example, when a virtual item of a treatment type needs to be used, the medicine wheel control is displayed instead of the thrown item wheel control. This better suits practical needs.

According to the method provided in this example, in response to different use operations for first virtual items for different functional uses, that the player-controlled virtual character uses the first virtual item or holds the first virtual item is further displayed, and therefore use of the virtual items for different functional uses is distinguished through the different use operations, so that the player can quickly use the virtual items for different functional uses, thereby meeting a requirement that the player needs the virtual items for different functional uses in different scenarios.

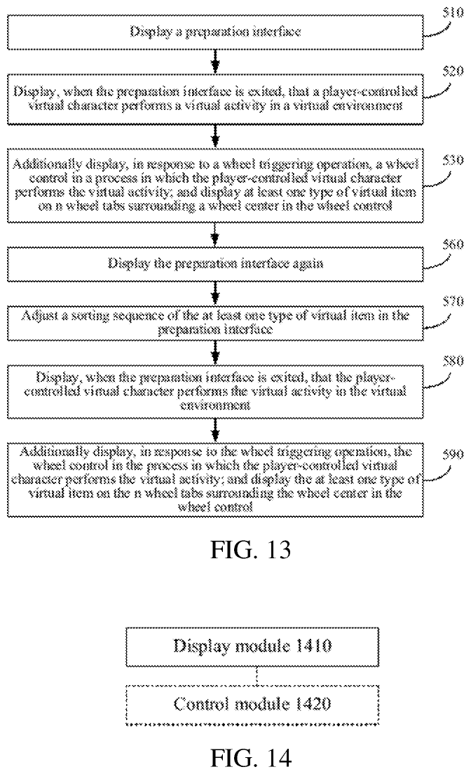

FIG. 13 is a flowchart of a wheel display method according to an aspect of this application. The method includes at least one of the following operations.

Operation 510. Display a preparation interface.

Operation 520. Display, when the preparation interface is exited, that a player-controlled virtual character performs a virtual activity in a virtual environment.

Operation 530. Additionally display, in response to a wheel triggering operation, a wheel control in a process in which the player-controlled virtual character performs the virtual activity; and display at least one type of virtual item on n wheel tabs surrounding a wheel center in the wheel control.

Operation 560. Display the preparation interface again.

When no virtual item is used, the preparation interface displayed again is the same as the preparation interface displayed in operation 510. For specific implementation details, refer to operation 510.

In a case that the virtual item is used or obtained, a virtual item displayed in the preparation interface is an updated virtual item. In a case that the virtual item is used, a virtual item displayed in the preparation interface is a used updated virtual item, and a remaining quantity and remaining categories of the updated virtual items are included. In a case that the virtual item is obtained, a virtual item displayed in the preparation interface is an obtained updated virtual item, including new quantities and new categories of the updated virtual items.

Operation 570. Adjust a sorting sequence of the at least one type of virtual item in the preparation interface.

A player may adjust a sorting sequence of the virtual item in the preparation interface. When the preparation interface is configured to display virtual items in a plurality of containers, the player may further move a virtual item from one container to another container.

As shown in FIG. 12, in comparison with FIG. 11, the player moves a smoke grenade and a flashbang from a pocket 211 to a chest rig 212, moves a surgical kit with 4/4 durability from a backpack 213 to the chest rig 212, moves a field kit with 69/400 durability from the chest rig 212 to the backpack 213, and moves a position of a field kit with 400/400 durability in the chest rig 212, and other virtual items are not moved.

Operation 580. Display, when the preparation interface is exited, that the player-controlled virtual character performs the virtual activity in the virtual environment.

For specific implementation details, refer to operation 520.

Operation 590. Additionally display, in response to the wheel triggering operation, the wheel control in the process in which the player-controlled virtual character performs the virtual activity; and display the at least one type of virtual item on the n wheel tabs surrounding the wheel center in the wheel control.

A display sequence of the at least one type of virtual item on the n wheel tabs is related to an adjusted sorting sequence of the at least one type of virtual item in the preparation interface.

After the player adjusts the sorting sequence of the at least one type of virtual item in the preparation interface, the display sequence of the at least one type of virtual item on the n wheel tabs also changes accordingly.

For example, in response to long pressing on a “V” key, a terminal device additionally displays a medicine wheel control 220. Only the surgical kit with 4/4 durability and the field kit with 400/400 durability in the pocket 211 and the chest rig 212 are virtual items for the treatment-type functional use, and in a sequence from left to right and from top to bottom, the surgical kit with 4/4 durability is displayed first, and then the field kit with 400/400 durability is displayed. Therefore, on two wheel tabs of the medicine wheel 220, starting from a wheel tab at the middle right, the terminal device first displays the surgical kit with 4/4 durability, followed clockwise by the field kit with 400/400 durability. Those are different from the virtual items displayed in FIG. 11 and the display sequence in FIG. 11.

In response to long pressing on a “G” key, a thrown item wheel 230 is displayed. A hand grenade in the pocket 211, and the flashbang and the smoke grenade in the chest rig 212 are virtual items for a throw-type functional use. In addition, in the chest rig 212, in a sequence from left to right and from top to bottom, three remaining smoke grenades are first displayed, and then one remaining flashbang is displayed Therefore, in the thrown item wheel 230, starting from a wheel tab at the middle right, the terminal device sequentially displays the two remaining hand grenades, the three remaining smoke grenades, and the one remaining flashbang, which is different from the display sequence in FIG. 11.

In conclusion, according to the method provided in this example, the sorting sequence of the at least one type of virtual item in the preparation interface is adjusted, so that the virtual items displayed on the n wheel tabs and/or the display sequence of the virtual items are/is changed, so that the virtual items displayed on the wheel tabs do not need to be manually set, thereby reducing operations.

In some aspects, the wheel display method is performed by a backend device or a server, and the method includes:
displaying, in response to the wheel triggering operation, in the process in which the player-controlled virtual character performs the virtual activity, in a sorting sequence of at least two types of virtual items in the preparation interface, the at least one type of virtual item on the n wheel tabs surrounding the wheel center in the wheel control.

The preparation interface includes at least two types of virtual items carried by the player-controlled virtual character, and the at least two types of virtual items each correspond to a sorting sequence.

The sorting sequence is a sequence obtained in a sorting manner. For example, in FIG. 2, virtual items in a chest rig 212 are sorted in a sorting manner from left to right and from top to bottom. The first virtual item is a surgical kit, the second virtual item is a field kit, and the third virtual item is a magazine.

If the sorting manner varies, an obtained sorting sequence also varies. It is assumed that in FIG. 2, the virtual items in the chest rig 212 are sorted in a sorting manner from right to left and from top to bottom. The first virtual item is the field kit, the second virtual item is the surgical kit, and the third virtual item is the magazine.

A display sequence of the at least one type of virtual item on the n wheel tabs is related to a sorting sequence of the at least one type of virtual item in the preparation interface, and n is a positive integer greater than 1. The wheel tab may be briefly referred to as a tab.

As shown in FIG. 2, in the preparation interface, in a sequence from left to right and from top to bottom, the surgical kit is the first virtual item, and the field kit is the second virtual item. Therefore, in the medicine wheel 220, starting from a tab at the middle right, a clockwise direction is used as a display sequence, the surgical kit is the first displayed virtual item, and the field kit is the second displayed virtual item.

In some aspects, in response to the wheel triggering operation, in the process in which the player-controlled virtual character performs the virtual activity, in a sorting sequence of at least two types of virtual items in the preparation interface, the at least one type of virtual item is displayed clockwise on the n wheel tabs, starting from a first tab of the wheel control. The first tab is a preset wheel tab in the n wheel tabs.

For example, the first tab is preset to be a tab at the middle right, a tab at the middle left, a tab at the top center, or a tab at the bottom center, or another wheel tab in the n wheel tabs. In this aspect of this application, an example in which the first tab is the tab at the middle right is usually used for description.

In one example, in response to the wheel triggering operation, in the process in which the player-controlled virtual character performs the virtual activity, in a sorting sequence of at least two types of virtual items in the preparation interface, the at least one type of virtual item is displayed anticlockwise on the n wheel tabs, starting from a first tab of the wheel control.

By way of example and not limitation, the sorting sequence of the at least two types of virtual items in the preparation interface includes a sequence obtained by sorting the at least two types of virtual items in a sorting manner from left to right and from top to bottom in the preparation interface.

For specific implementation details, refer to operation 532 in the example in FIG. 6. Details are not described herein again.

In some aspects, in response to the wheel triggering operation, in the process in which the player-controlled virtual character performs the virtual activity, based on a sorting sequence of at least two types of virtual items in the preparation interface and corresponding state information, the at least one type of virtual item and the corresponding state information are displayed on the n wheel tabs surrounding the wheel center in the wheel control. Virtual items of the same type but different state information are respectively displayed on different wheel tabs.

As shown in FIG. 4, on the wheel tabs, the two virtual items of the same type but different state information: the field kit with 400/400 durability and the field kit with 69/400 durability are respectively displayed.

In some aspects, the preparation interface is configured to display at least two types of virtual items in at least two containers, and the at least two containers include at least two of the following: a first container, a second container, and a third container.

In response to the wheel triggering operation, in the process in which the player-controlled virtual character performs the virtual activity, in sorting sequences of the at least two types of virtual items in the at least two containers, the at least one type of virtual item is displayed on the n wheel tabs surrounding the wheel center in the wheel control.

In one example, a clockwise display sequence of the virtual item for the first functional use in the first container on the n wheel tabs is the same as a sorting sequence of the virtual item for the first functional use in the first container; and
a start tab for displaying the virtual item for the first functional use in the second container is a next wheel tab of an end tab for displaying the virtual item for the first functional use in the first container, and a clockwise display sequence of the virtual item for the first functional use in the second container on the n wheel tabs is the same as a sorting sequence of the virtual item for the first functional use in the second container.

In some aspects, in response to the wheel triggering operation, in the process in which the player-controlled virtual character performs the virtual activity, in sorting sequences of the at least two types of virtual items in the first container and the second container, i virtual items for the first functional use in the first container and j virtual items for the first functional use in the second container are displayed on the n wheel tabs surrounding the wheel center in the wheel control, i and j being positive integers, i being less than or equal to n, and j being less than or equal to n−i.

For specific implementation details, refer to operation 532 in the example in FIG. 6. Details are not described herein again.

The foregoing examples are described by using an example in which the wheel display method is implemented in a scenario in which external devices are a mouse and a keyboard. In some aspects, the wheel display method may alternatively be applied to a smartphone scenario or a handle scenario.

Smartphone scenario:

In some aspects, the wheel display method is performed by a client on a smartphone, and the method includes:
displaying a preparation interface, the preparation interface including at least two types of virtual items carried by a player-controlled virtual character, and the at least two types of virtual items each corresponding to a sorting sequence;
displaying, when the preparation interface is exited, that the player-controlled virtual character performs a virtual activity in a virtual environment;
additionally displaying, in response to a wheel triggering operation, a wheel control in a process in which the player-controlled virtual character performs the virtual activity; and
displaying at least one type of virtual item on n wheel tabs surrounding a wheel center in the wheel control, a display sequence of the at least one type of virtual item on the n wheel tabs being related to a sorting sequence of the at least one type of virtual item in the preparation interface, and n being a positive integer greater than 1.

In some aspects, a clockwise display sequence of the at least one type of virtual item on the n wheel tabs is the same as the sorting sequence of the at least one type of virtual item in the preparation interface; or
an anticlockwise display sequence of the at least one type of virtual item on the n wheel tabs is the same as the sorting sequence of the at least one type of virtual item in the preparation interface,
a starting tab for displaying the at least one type of virtual item being a first tab of the wheel control, and the first tab being a preset wheel tab in the n wheel tabs.

In some aspects, a quantity of the at least two types of virtual items is greater than or equal to n, the at least one type of virtual item includes first n virtual items in the at least two types of virtual items, a clockwise display sequence of the first n virtual items on the n wheel tabs is the same as a sorting sequence of the first n virtual items in the preparation interface, and the first n virtual items are determined in the sorting sequence of the at least two types of virtual items in the preparation interface; or
a quantity of the at least two types of virtual items is k, the at least one type of virtual item includes k virtual items, a clockwise display sequence of the k virtual items on k wheel tabs is the same as a sorting sequence of the k virtual items in the preparation interface, and k is a positive integer less than n; or
a quantity of the at least two types of virtual items is p, the at least one type of virtual item includes p virtual items, a clockwise display sequence of the p virtual items on q wheel tabs is related to a sorting sequence of the p virtual items in the preparation interface, identical virtual items in the p virtual items are combined into the same wheel tab, p and q are positive integers less than n, and p is greater than q.

In some aspects, the sorting sequence of the at least two types of virtual items in the preparation interface includes a sequence obtained by sorting the at least two types of virtual items in a sorting manner from left to right and from top to bottom in the preparation interface.

In some aspects, virtual items of different types and/or virtual items of the same type but different state information are respectively displayed on different wheel tabs of the n wheel tabs,
the type being configured for distinguishing virtual items of different types, and the state information indicating a current state of the virtual item.

In some aspects, in response to a first wheel triggering operation, a first wheel control is additionally displayed in the process in which the player-controlled virtual character performs the virtual activity; and/or in response to a second wheel triggering operation, a second wheel control is additionally displayed in the process in which the player-controlled virtual character performs the virtual activity,
a virtual item for a first functional use being displayed on the first wheel control, and a virtual item for a second functional use being displayed on the second wheel control.

In some aspects, the preparation interface is configured to display at least two types of virtual items in at least two containers, and the at least two containers include at least two of the following: a first container, a second container, and a third container;
a clockwise display sequence of the virtual item for the first functional use in the first container on the n wheel tabs is the same as a sorting sequence of the virtual item for the first functional use in the first container; and
a start tab for displaying the virtual item for the first functional use in the second container is a next wheel tab of an end tab for displaying the virtual item for the first functional use in the first container, and a clockwise display sequence of the virtual item for the first functional use in the second container on the n wheel tabs is the same as a sorting sequence of the virtual item for the first functional use in the second container.

In some aspects, i virtual items for the first functional use in the first container and j virtual items for the first functional use in the second container are displayed on n wheel tabs surrounding a wheel center in the first wheel control, i and j being positive integers, i being less than or equal to n, and j being less than or equal to n−i.

For specific implementation details, refer to the foregoing example of the mouse and keyboard scenario. Details are not described herein again.

In some aspects, the smartphone includes a touchscreen. In response to long pressing on a first control on the touchscreen, a medicine wheel control is additionally displayed in the process in which the player-controlled virtual character performs the virtual activity, and at least one type of virtual item for a treatment-type functional use is displayed on the n wheel tabs surrounding the wheel center in the wheel control.

For example, in response to long pressing on a treatment-type prop control on the touchscreen, the medicine wheel control is displayed, and the at least one type of virtual item for the treatment-type functional use is displayed on eight wheel tabs.

In some aspects, in response to long pressing on a second control on the touchscreen, a thrown item wheel control is additionally displayed in the process in which the player-controlled virtual character performs the virtual activity, and at least one type of virtual item for a throw-type functional use is displayed on the n wheel tabs surrounding the wheel center in the wheel control.

For example, in response to long pressing on a throw-type prop control on the touchscreen, the thrown item wheel control is displayed, and the at least one type of virtual item for the throw-type functional use is displayed on eight wheel tabs.

An interaction operation for displaying the wheel control may include other possible operations. The foregoing interaction operation is merely used as an example, and is not limited in this aspect of this application.

In some aspects, the method further includes: highlighting, in response to a sliding selection operation on a virtual item on the wheel control after the wheel control is displayed, a wheel tab corresponding to the virtual item that is currently selected through sliding; and
selecting, in response to a sliding operation of a finger on the touchscreen, the virtual item on the corresponding wheel control based on a position of the finger. When the finger does not leave the touchscreen, a selection state is maintained. After the finger leaves the touchscreen, the virtual item on the corresponding wheel control is selected based on a leaving position of the finger.

In some aspects, the method further includes: closing the wheel control in response to a tapping operation on a region outside the wheel control. The wheel control is closed by tapping any region outside the wheel control, and the wheel control and at least one corresponding virtual item are not displayed.

In some aspects, the method further includes: setting, as a selected first virtual item, a virtual item corresponding to a wheel tab located in a first direction, starting from the wheel center, in response to a movement control operation moving in the first direction; and
displaying, in response to a use operation for the first virtual item, that the player-controlled virtual character uses the first virtual item or holds the first virtual item,
the first direction including at least one of the following directions: top center, top right, middle right, bottom right, bottom center, bottom left, middle left, and top left.

For example, in response to moving a virtual direction joystick toward the top center of the touchscreen, a virtual item corresponding to a wheel tab located at the top center, starting from the wheel center, is set as the selected first virtual item.

In some aspects, in response to an operation of tapping a third control for the first virtual item, that the player-controlled virtual character uses the first virtual item or holds the first virtual item is displayed.

In response to an operation of releasing a control that is being long-pressed for the first virtual item, that the player-controlled virtual character uses the first virtual item or holds the first virtual item is displayed, the control that is being long-pressed being a control corresponding to the wheel triggering operation.

For example, in response to performing an operation of tapping confirmation controls for virtual items for different functional uses, that the player-controlled virtual character uses a virtual item for a treatment-type functional use or holds a virtual item for a throw-type functional use is displayed.

In response an operation of releasing the first control that is being long-pressed performed for the virtual item for the treatment-type functional use, that the player-controlled virtual character uses the virtual item for the treatment-type functional use is displayed. In response an operation of releasing the second control that is being long-pressed performed for the virtual item for the throw-type functional use, that the player-controlled virtual character holds the virtual item for the throw-type functional use is displayed.

In some aspects, the method further includes: displaying, in a period in which the player-controlled virtual character continuously uses the first virtual item, in response to a tapping operation on a fourth control, that the player-controlled virtual character interrupts use of the first virtual item.

For example, in a period in which the player-controlled virtual character continuously uses the virtual item for the treatment-type functional use, in response to a tapping operation on a cancel control, that the player-controlled virtual character interrupts use of the virtual item for the treatment-type functional use is displayed.

In some aspects, the method further includes: displaying, in a period in which the player-controlled virtual character holds the first virtual item, in response to a long-press operation on a fifth control, that the player-controlled virtual character prepares to throw the first virtual item, and displaying, in response to a releasing operation on the fifth control, that the player-controlled virtual character throws the first virtual item at a first height; and
displaying, in response to a long-press operation on a sixth control, that the player-controlled virtual character prepares to throw the first virtual item, and displaying, in response to a releasing operation on the sixth control, that the player-controlled virtual character throws the first virtual item at a second height, the second height being lower than the first height.

For example, an example in which the first virtual item is a hand grenade in the virtual item for the throw-type functional use is used. In a period in which the player-controlled virtual character holds the hand grenade, in response to a long-press operation on a high-throw control, that the player-controlled virtual character pulls a pull ring of the hand grenade, to prepare to throw the hand grenade is displayed; and in response to a releasing operation on the high-throw control, that the player-controlled virtual character throws the hand grenade at the first height is displayed.

In response to a long-press operation on a low-throw control, that the player-controlled virtual character pulls a pull ring of the hand grenade, to prepare to throw the hand grenade is displayed; and in response to a releasing operation on the low-throw control, that the player-controlled virtual character throws the hand grenade at the second height is displayed. The second height is lower than the first height.

In some aspects, the method further includes: displaying, in a period in which the player-controlled virtual character holds the first virtual item, in response to an operation of switching the first virtual item currently held, that the player-controlled virtual character holds another virtual item.

For example, in a period in which the player-controlled virtual character holds a hand grenade, or pulls a pull ring of the hand grenade but has not thrown the hand grenade, in response to switching the currently held hand grenade to a smoke grenade, that the player-controlled virtual character holds the smoke grenade is displayed.

In some aspects, the method further includes: displaying the preparation interface again;
adjusting the sorting sequence of the at least one type of virtual item in the preparation interface;
displaying, when the preparation interface is exited, that the player-controlled virtual character performs a virtual activity in a virtual environment;
additionally displaying, in response to a wheel triggering operation, a wheel control in a process in which the player-controlled virtual character performs the virtual activity; and
displaying the at least one type of virtual item on the n wheel tabs surrounding the wheel center in the wheel control, the display sequence of the at least one type of virtual item on the n wheel tabs being related to an adjusted sorting sequence of the at least one type of virtual item in the preparation interface.

A player may adjust a sorting sequence of the virtual item in the preparation interface. When the preparation interface is configured to display virtual items in at least two containers, the player may further move a virtual item from one container to another container. After the player adjusts the sorting sequence of the at least one type of virtual item in the preparation interface, the display sequence of the at least one type of virtual item on the n wheel tabs also changes accordingly.

For specific implementation details, refer to the foregoing example of the mouse and keyboard scenario. Details are not described herein again.

Handle scenario:

In some aspects, the wheel display method is performed by a client connected to a handle, and the method includes:
displaying a preparation interface, the preparation interface including at least two types of virtual items carried by a player-controlled virtual character, and the at least two types of virtual items each corresponding to a sorting sequence;
displaying, when the preparation interface is exited, that the player-controlled virtual character performs a virtual activity in a virtual environment;
additionally displaying, in response to a wheel triggering operation, a wheel control in a process in which the player-controlled virtual character performs the virtual activity; and
displaying at least one type of virtual item on n wheel tabs surrounding a wheel center in the wheel control, a display sequence of the at least one type of virtual item on the n wheel tabs being related to a sorting sequence of the at least one type of virtual item in the preparation interface, and n being a positive integer greater than 1.

In some aspects, a clockwise display sequence of the at least one type of virtual item on the n wheel tabs is the same as the sorting sequence of the at least one type of virtual item in the preparation interface; or
an anticlockwise display sequence of the at least one type of virtual item on the n wheel tabs is the same as the sorting sequence of the at least one type of virtual item in the preparation interface,
a starting tab for displaying the at least one type of virtual item being a first tab of the wheel control, and the first tab being a preset wheel tab in the n wheel tabs.

In some aspects, a quantity of the at least two types of virtual items is greater than or equal to n, the at least one type of virtual item includes first n virtual items in the at least two types of virtual items, a clockwise display sequence of the first n virtual items on the n wheel tabs is the same as a sorting sequence of the first n virtual items in the preparation interface, and the first n virtual items are determined in the sorting sequence of the at least two types of virtual items in the preparation interface; or
a quantity of the at least two types of virtual items is k, the at least one type of virtual item includes k virtual items, a clockwise display sequence of the k virtual items on k wheel tabs is the same as a sorting sequence of the k virtual items in the preparation interface, and k is a positive integer less than n; or
a quantity of the at least two types of virtual items is p, the at least one type of virtual item includes p virtual items, a clockwise display sequence of the p virtual items on q wheel tabs is related to a sorting sequence of the p virtual items in the preparation interface, identical virtual items in the p virtual items are combined into the same wheel tab, p and q are positive integers less than n, and p is greater than q.

In some aspects, the sorting sequence of the at least two types of virtual items in the preparation interface includes a sequence obtained by sorting the at least two types of virtual items in a sorting manner from left to right and from top to bottom in the preparation interface.

In some aspects, virtual items of different types and/or virtual items of the same type but different state information are respectively displayed on different wheel tabs of the n wheel tabs,
the type being configured for distinguishing virtual items of different types, and the state information indicating a current state of the virtual item.

In some aspects, in response to a first wheel triggering operation, a first wheel control is additionally displayed in the process in which the player-controlled virtual character performs the virtual activity; and/or in response to a second wheel triggering operation, a second wheel control is additionally displayed in the process in which the player-controlled virtual character performs the virtual activity,
a virtual item for a first functional use being displayed on the first wheel control, and a virtual item for a second functional use being displayed on the second wheel control.

In some aspects, the preparation interface is configured to display at least two types of virtual items in at least two containers, and the at least two containers include at least two of the following: a first container, a second container, and a third container;
a clockwise display sequence of the virtual item for the first functional use in the first container on the n wheel tabs is the same as a sorting sequence of the virtual item for the first functional use in the first container; and
a start tab for displaying the virtual item for the first functional use in the second container is a next wheel tab of an end tab for displaying the virtual item for the first functional use in the first container, and a clockwise display sequence of the virtual item for the first functional use in the second container on the n wheel tabs is the same as a sorting sequence of the virtual item for the first functional use in the second container.

In some aspects, i virtual items for the first functional use in the first container and j virtual items for the first functional use in the second container are displayed on n wheel tabs surrounding a wheel center in the first wheel control, i and j being positive integers, i being less than or equal to n, and j being less than or equal to n−i.

For specific implementation details, refer to the foregoing example of the mouse and keyboard scenario. Details are not described herein again.

In some aspects, an operation apparatus on the handle includes, but is not limited to, a left trigger key or a right trigger key, and the additionally displaying, in response to a wheel triggering operation, a wheel control in a process in which the player-controlled virtual character performs the virtual activity includes:
additionally displaying, in response to long pressing on the left trigger key, a medicine wheel control in the process in which the player-controlled virtual character performs the virtual activity and displaying at least one type of virtual item for a treatment-type functional use on the n wheel tabs surrounding the wheel center in the wheel control.

For example, in response to long pressing on the left trigger key on the handle, a medicine wheel control is displayed and the at least one type of virtual item for the treatment-type functional use is displayed on eight wheel tabs.

In some aspects, in response to long pressing on the right trigger key, a thrown item wheel control is additionally displayed in the process in which the player-controlled virtual character performs the virtual activity and at least one type of virtual item for a throw-type functional use is displayed on the n wheel tabs surrounding the wheel center in the wheel control.

For example, in response to long pressing on right trigger key on the handle, a thrown item wheel control is displayed, and the at least one type of virtual item for the throw-type functional use is displayed on eight wheel tabs.

An interaction operation for displaying the wheel control may include other possible operations. The foregoing interaction operation is merely used as an example, and is not limited in this aspect of this application.

In some aspects, the operation apparatus on the handle further includes a direction joystick, and the method further includes: highlighting, in response to a rotation selection operation on a virtual item on the wheel control after the wheel control is displayed, a wheel tab corresponding to the virtual item that is currently selected through rotation; and selecting, by rotating the direction joystick on the handle, the virtual item on the n wheel tabs surrounding the wheel center in the wheel control.

In some aspects, the operation apparatus on the handle further includes a confirmation key, and the method further includes: using a selected virtual item in response to a clicking operation on the confirmation key during selection of the virtual item.

The finally selected virtual item is used by clicking the confirmation key on the handle, that is, a virtual item corresponding to the highlighted wheel tab.

In some aspects, the operation apparatus on the handle further includes a cancel key, and the method further includes: closing the wheel control in response to a clicking operation on the cancel key during selection of the virtual item.

The wheel control is closed by clicking the cancel key on the handle, and the wheel control and at least one corresponding virtual item are not displayed.

In some aspects, the method further includes: setting, as a selected first virtual item, a virtual item corresponding to a wheel tab located in a first direction, starting from the wheel center, in response to a movement control operation moving in the first direction; and
displaying, in response to a use operation for the first virtual item, that the player-controlled virtual character uses the first virtual item or holds the first virtual item,
the first direction including at least one of the following directions: top center, top right, middle right, bottom right, bottom center, bottom left, middle left, and top left.

For example, the operation apparatus on the handle further includes the direction joystick, and in response to moving the direction joystick toward the top center, a virtual item corresponding to a wheel tab located at the top center from the wheel center is set as the selected first virtual item.

In some aspects, the operation apparatus on the handle further includes the confirmation key, and in response to an operation of clicking the confirmation key for the first virtual item, that the player-controlled virtual character uses the first virtual item or holds the first virtual item is displayed.

In response to an operation of releasing a key that is being long-pressed for the first virtual item, that the player-controlled virtual character uses the first virtual item or holds the first virtual item is displayed, the key that is being long-pressed being a key corresponding to the wheel triggering operation.

For example, in response to performing an operation of clicking confirmation keys for virtual items for different functional uses, that the player-controlled virtual character uses a virtual item for a treatment-type functional use or holds a virtual item for a throw-type functional use is displayed.

In response an operation of releasing the left trigger key that is being long-pressed performed for the virtual item for the treatment-type functional use, that the player-controlled virtual character uses the virtual item for the treatment-type functional use is displayed. In response an operation of releasing the right trigger key that is being long-pressed performed for the virtual item for the throw-type functional use, that the player-controlled virtual character holds the virtual item for the throw-type functional use is displayed.

In some aspects, the operation apparatus on the handle further includes the cancel key, and the method further includes: displaying, in a period in which the player-controlled virtual character continuously uses the first virtual item, in response to a clicking operation on the cancel key, that the player-controlled virtual character interrupts use of the first virtual item.

For example, in a period in which the player-controlled virtual character continuously uses the virtual item for the treatment-type functional use, in response to a clicking operation on the cancel key, that the player-controlled virtual character interrupts use of the virtual item for the treatment-type functional use is displayed.

In some aspects, the method further includes: displaying, in a period in which the player-controlled virtual character holds the first virtual item, in response to a long-press operation on the confirmation key, that the player-controlled virtual character prepares to throw the first virtual item, and displaying, in response to a releasing operation on the confirmation key, that the player-controlled virtual character throws the first virtual item at a first height; and
displaying, in response to a long-press operation on the cancel key, that the player-controlled virtual character prepares to throw the first virtual item, and displaying, in response to a releasing operation on the cancel key, that the player-controlled virtual character throws the first virtual item at a second height, the second height being lower than the first height.

For example, an example in which the first virtual item is a hand grenade in the virtual item for the throw-type functional use is used. In a period in which the player-controlled virtual character holds the hand grenade, in response to a long-press operation on the confirmation key, that the player-controlled virtual character pulls a pull ring of the hand grenade, to prepare to throw the hand grenade is displayed; and in response to a releasing operation on the confirmation key, that the player-controlled virtual character throws the hand grenade at the first height is displayed.

In response to a long-press operation on the cancel key, that the player-controlled virtual character pulls a pull ring of the hand grenade, to prepare to throw the hand grenade is displayed; and in response to a releasing operation on the cancel key, that the player-controlled virtual character throws the hand grenade at the second height is displayed. The second height is lower than the first height.

In some aspects, the method further includes: displaying, in a period in which the player-controlled virtual character holds the first virtual item, in response to an operation of switching the first virtual item currently held, that the player-controlled virtual character holds another virtual item.

For example, in a period in which the player-controlled virtual character holds a hand grenade, or pulls a pull ring of the hand grenade but has not thrown the hand grenade, in response to switching the currently held hand grenade to a smoke grenade, that the player-controlled virtual character holds the smoke grenade is displayed.

In some aspects, the method further includes: displaying the preparation interface again;
adjusting the sorting sequence of the at least one type of virtual item in the preparation interface;
displaying, when the preparation interface is exited, that the player-controlled virtual character performs a virtual activity in a virtual environment;
additionally displaying, in response to a wheel triggering operation, a wheel control in a process in which the player-controlled virtual character performs the virtual activity; and
displaying the at least one type of virtual item on the n wheel tabs surrounding the wheel center in the wheel control, the display sequence of the at least one type of virtual item on the n wheel tabs being related to an adjusted sorting sequence of the at least one type of virtual item in the preparation interface.

A player may adjust a sorting sequence of the virtual item in the preparation interface. When the preparation interface is configured to display virtual items in at least two containers, the player may further move a virtual item from one container to another container. After the player adjusts the sorting sequence of the at least one type of virtual item in the preparation interface, the display sequence of the at least one type of virtual item on the n wheel tabs also changes accordingly.

For specific implementation details, refer to the foregoing example of the mouse and keyboard scenario. Details are not described herein again.

In the foregoing examples, operations with the same sequence number may be considered as the same operation. The example corresponding to FIG. 5, the example corresponding to FIG. 6, the example corresponding to FIG. 10, and the example corresponding to FIG. 13 may be independently implemented, or may be implemented in combination. This is not limited in this application.

FIG. 14 is a block diagram of a wheel display apparatus according to an aspect of this application. The apparatus may be implemented as a computer device or a part of the computer device by using software or hardware, or a combination thereof. The apparatus includes:
a display module 1410, configured to display a preparation interface, the preparation interface including at least two types of virtual items carried by a player-controlled virtual character, and the at least two types of virtual items each corresponding to a sorting sequence,
the display module 1410 being configured to display, when the preparation interface is exited, that the player-controlled virtual character performs a virtual activity in a virtual environment; and
the display module 1410 being configured to: additionally display, in response to a wheel triggering operation, a wheel control in a process in which the player-controlled virtual character performs the virtual activity, and
display at least one type of virtual item on n wheel tabs surrounding a wheel center in the wheel control, a display sequence of the at least one type of virtual item on the n wheel tabs being related to a sorting sequence of the at least one type of virtual item in the preparation interface, and n being a positive integer greater than 1.

In a possible design of this example, a clockwise display sequence of the at least one type of virtual item on the n wheel tabs is the same as the sorting sequence of the at least one type of virtual item in the preparation interface; or
an anticlockwise display sequence of the at least one type of virtual item on the n wheel tabs is the same as the sorting sequence of the at least one type of virtual item in the preparation interface,
a starting tab for displaying the at least one type of virtual item being a first tab of the wheel control, and the first tab being a preset wheel tab in the n wheel tabs.

In a possible design of this example, a quantity of the at least two types of virtual items is greater than or equal to n, the at least one type of virtual item includes first n virtual items in the at least two types of virtual items, a clockwise display sequence of the first n virtual items on the n wheel tabs is the same as a sorting sequence of the first n virtual items in the preparation interface, and the first n virtual items are determined in the sorting sequence of the at least two types of virtual items in the preparation interface; or
a quantity of the at least two types of virtual items is k, the at least one type of virtual item includes k virtual items, a clockwise display sequence of the k virtual items on k wheel tabs is the same as a sorting sequence of the k virtual items in the preparation interface, and k is a positive integer less than n; or
a quantity of the at least two types of virtual items is p, the at least one type of virtual item includes p virtual items, a clockwise display sequence of the p virtual items on q wheel tabs is related to a sorting sequence of the p virtual items in the preparation interface, identical virtual items in the p virtual items are combined into the same wheel tab, p and q are positive integers less than n, and p is greater than q.

In a possible design of this example, the sorting sequence of the at least two types of virtual items in the preparation interface includes a sequence obtained by sorting the at least two types of virtual items in a sorting manner from left to right and from top to bottom in the preparation interface.

In a possible design of this example, virtual items of different types and/or virtual items of the same type but different state information are respectively displayed on different wheel tabs of the n wheel tabs,
the type being configured for distinguishing virtual items of different types, and the state information indicating a current state of the virtual item.

In a possible design of this example, the display module 1410 is configured to: additionally display, in response to a first wheel triggering operation, a first wheel control in the process in which the player-controlled virtual character performs the virtual activity; and/or additionally display, in response to a second wheel triggering operation, a second wheel control in the process in which the player-controlled virtual character performs the virtual activity,
a virtual item for a first functional use being displayed on the first wheel control, and a virtual item for a second functional use being displayed on the second wheel control.

In a possible design of this example, the preparation interface is configured to display at least two types of virtual items in at least two containers, and the at least two containers include at least two of the following: a first container, a second container, and a third container;
a clockwise display sequence of the virtual item for the first functional use in the first container on the n wheel tabs is the same as a sorting sequence of the virtual item for the first functional use in the first container; and
a start tab for displaying the virtual item for the first functional use in the second container is a next wheel tab of an end tab for displaying the virtual item for the first functional use in the first container, and a clockwise display sequence of the virtual item for the first functional use in the second container on the n wheel tabs is the same as a sorting sequence of the virtual item for the first functional use in the second container.

In a possible design of this example, the display module 1410 is configured to display i virtual items for the first functional use in the first container and j virtual items for the first functional use in the second container on n wheel tabs surrounding a wheel center in the first wheel control, i and j being positive integers, i being less than or equal to n, and j being less than or equal to n−i.

In a possible design of this example, the display module 1410 is configured to: additionally display, in response to long pressing on a first key, a medicine wheel control in the process in which the player-controlled virtual character performs the virtual activity; and display at least one type of virtual item for a treatment-type functional use on the n wheel tabs surrounding the wheel center in the wheel control.

The display module 1410 is configured to: additionally display, in response to long pressing on a second key, a thrown item wheel control in the process in which the player-controlled virtual character performs the virtual activity; and display at least one type of virtual item for a throw-type functional use on the n wheel tabs surrounding the wheel center in the wheel control.

In a possible design of this example, a control module 1420 is configured to set, as a selected first virtual item, a virtual item corresponding to a wheel tab located in a first direction, starting from the wheel center, in response to a movement control operation moving in the first direction; and
the display module 1410 is configured to display, in response to a use operation for the first virtual item, that the player-controlled virtual character uses the first virtual item or holds the first virtual item,
the first direction including at least one of the following directions: top center, top right, middle right, bottom right, bottom center, bottom left, middle left, and top left.

In a possible design of this example, the display module 1410 is configured to display, in response to an operation of clicking/tapping the first key for the first virtual item, that the player-controlled virtual character uses the first virtual item or holds the first virtual item; and
the display module 1410 is configured to display, in response to an operation of releasing a key that is being long-pressed for the first virtual item, that the player-controlled virtual character uses the first virtual item or holds the first virtual item, the key that is being long-pressed being a key corresponding to the wheel triggering operation.

In a possible design of this example, the display module 1410 is further configured to display, in a period in which the player-controlled virtual character continuously uses the first virtual item, in response to a clicking/tapping operation on the second key, that the player-controlled virtual character interrupts use of the first virtual item.

In a possible design of this example, the display module 1410 is further configured to display, in a period in which the player-controlled virtual character holds the first virtual item, in response to a long-press operation on the first key, that the player-controlled virtual character prepares to throw the first virtual item, and display, in response to a releasing operation on the first key, that the player-controlled virtual character throws the first virtual item at a first height; and
display, in response to a long-press operation on the second key, that the player-controlled virtual character prepares to throw the first virtual item, and display, in response to a releasing operation on the second key, that the player-controlled virtual character throws the first virtual item at a second height, the second height being lower than the first height.

In a possible design of this example, the display module 1410 is further configured to display, in a period in which the player-controlled virtual character holds the first virtual item, in response to an operation of switching the first virtual item currently held, that the player-controlled virtual character holds another virtual item.

In a possible design of this example, the display module 1410 is configured to display the preparation interface again; and
the control module 1420 is configured to adjust the sorting sequence of the at least one type of virtual item in the preparation interface,
the display module 1410 being configured to display, when the preparation interface is exited, that the player-controlled virtual character performs a virtual activity in a virtual environment; and
additionally display, in response to a wheel triggering operation, a wheel control in a process in which the player-controlled virtual character performs the virtual activity; and display the at least one type of virtual item on the n wheel tabs surrounding the wheel center in the wheel control, the display sequence of the at least one type of virtual item on the n wheel tabs being related to an adjusted sorting sequence of the at least one type of virtual item in the preparation interface.

In this example, the display module 1410 may be split into at least one display submodule, and each display submodule, for example, a first display submodule, a second display submodule, and a third display submodule, is configured to perform the foregoing at least one display operation. The first display submodule is configured to display the preparation interface; the second display submodule is configured to display, in response to exiting the preparation interface, that the player-controlled virtual character performs the virtual activity in the virtual environment; and the third display submodule is configured to: additionally display, in response to the wheel triggering operation, the wheel control in the process of performing the virtual activity, and display the at least one type of virtual item on the n wheel tabs surrounding the wheel center in the wheel control. Alternatively, the first display submodule is configured to display, in response to exiting the preparation interface, that the player-controlled virtual character performs the virtual activity in the virtual environment; the second display submodule is configured to: additionally display, in response to the wheel triggering operation, the wheel control in the process of performing the virtual activity, and display the at least one type of virtual item on the n wheel tabs surrounding the wheel center in the wheel control; and the third display submodule is configured to display the preparation interface. Alternatively, the first display submodule is configured to: additionally display, in response to the wheel triggering operation, the wheel control in the process of performing the virtual activity, and display the at least one type of virtual item on the n wheel tabs surrounding the wheel center in the wheel control; the second display submodule is configured to display the preparation interface; and the third display submodule is configured to display, in response to exiting the preparation interface, that the player-controlled virtual character performs the virtual activity in the virtual environment. Functions of different display submodules are not limited in this example.

In this example, one display module 1410 and one control module 1420 are used as an example for description, and quantities of the display module 1410 and the control module 1420 are not limited.

For descriptions of functions of the display module 1410, refer to content of operation 510, operation 520, and operation 530 in the example of FIG. 5, content of operation 532 in the example of FIG. 6, content of operation 534 and operation 550 in the example of FIG. 10, and content of operation 560, operation 580, and operation 590 in the example of FIG. 13. For descriptions of functions of the control module 1420, refer to content of operation 540 in the example of FIG. 10 and content of operation 570 in the example of FIG. 13.

An aspect of this application further provides a computer device, including a processor and a memory, the memory having at least one segment of program stored therein; and the processor being configured to execute the at least one segment of program in the memory to implement the wheel display method according to the foregoing method examples.

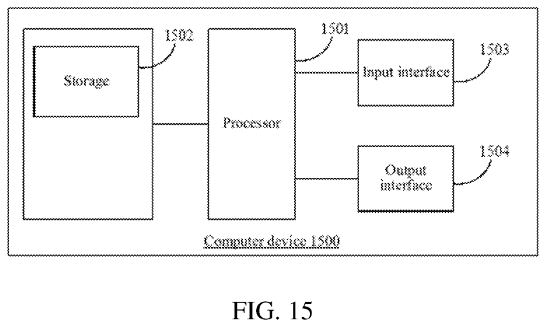

FIG. 15 is a block diagram of a structure of a computer device 1500 according to an aspect of this application. Usually, the computer device 1500 includes: a processor 1501 and a memory 1502.

The processor 1501 may include one or more processing cores, for example, a 4-core processor or an 8-core processor. The processor 1501 may be implemented in at least one hardware form of digital signal processing (DSP), a field-programmable gate array (FPGA), and a programmable logic array (PLA). The processor 1501 may alternatively include a main processor and a coprocessor. The main processor is a processor configured to process data in an active state, and is also referred to as a central processing unit (CPU). The coprocessor is a low-power processor configured to process data in a standby state. In some embodiments, the processor 1501 may include a graphics processing unit (GPU). The GPU is configured to render and draw content that needs to be displayed on a display screen. In some embodiments, the processor 1501 may further include an artificial intelligence (AI) processor. The AI processor is configured to process computing operations related to machine learning.

The memory 1502 may include one or more computer-readable storage media. The computer-readable storage medium may be non-transient. The memory 1502 may further include a high-speed random access memory and a non-volatile memory such as one or more magnetic disk storage devices and a flash storage device. In some aspects, the non-transitory computer-readable storage medium in the memory 1502 is configured to store at least one instruction, and the at least one instruction is configured to be executed by the processor 1501 to implement the wheel display method provided in method examples of this application.

In some aspects, the computer device 1500 may further include: an input interface 1503 and an output interface 1504. The processor 1501, the memory 1502, the input interface 1503, and the output interface 1504 may be connected through a bus or a signal cable. Each peripheral device may be connected to the input interface 1503 and the output interface 1504 through the bus, the signal cable, or a circuit board. The input interface 1503 and the output interface 1504 may be configured to connect at least one peripheral device related to input/output to the processor 1501 and the memory 1502. In some aspects, the processor 1501, the memory 1502, the input interface 1503, and the output interface 1504 are integrated on the same chip or the same circuit board. In some other aspects, any one or two of the processor 1501, the memory 1502, the input interface 1503, and the output interface 1504 may be implemented on an independent chip or circuit board. This is not limited in aspects of this application.

A person skilled in the art may understand that the foregoing structure does not constitute a limitation on the computer device 1500, and the computer device 1500 may include more components or fewer components than those shown in the figure, or some components may be combined, or a different component deployment may be used.

In an aspect, a chip is further provided. The chip includes a programmable logic circuit and/or program instructions. When the chip is run on a computer device 1500, the chip is configured to implement the wheel display method provided in method examples of this application.

In an aspect, a computer program product is further provided. The computer program product includes computer instructions. The computer instructions are stored in a computer-readable storage medium, and a processor obtains the computer instructions from the computer-readable storage medium and executes the computer instructions, to implement the wheel display method provided in method examples of this application.

In an aspect, a computer-readable storage medium is further provided. The computer-readable storage medium has at least one segment of program stored thereon, and the at least one segment of program is loaded and executed by a processor to implement the wheel display method provided in method examples of this application.

A person of ordinary skill in the art may understand that all or some of the operations of the foregoing examples may be implemented by hardware, or may be implemented by a program instructing relevant hardware. The program may be stored in a computer-readable storage medium. The computer-readable storage medium may be a read-only memory, a magnetic disk, an optical disc, or the like.

A person skilled in the art will be aware that in the foregoing one or more examples, functions described in aspects of this application may be implemented by hardware, software, firmware, or any combination thereof. When implemented by software, the functions may be stored in a computer-readable storage medium or transmitted as one or more instructions or code in a computer-readable storage medium. The computer-readable storage medium includes a computer storage medium and a communication medium. The communication medium includes any medium that facilitates transfer of a computer program from one place to another place. The storage medium may be any available medium accessible to a general purpose or a dedicated computer.

The foregoing descriptions are merely examples of this application, but are not intended to limit this application. Any modification, equivalent replacement, or improvement made without departing from the spirit and principle of this application needs to fall within the protection scope of this application.

What is claimed is:

1. A wheel display method, performed by a computer device, and comprising:
displaying a preparation interface comprising at least two types of virtual items carried by a player-controlled virtual character, and the at least two types of virtual items each corresponding to a sorting sequence;
displaying, after the preparation interface is exited, that the player-controlled virtual character performs a virtual activity in a virtual environment;
displaying, in response to a wheel triggering operation, a wheel control in a process in which the player-controlled virtual character performs the virtual activity; and
displaying at least one type of virtual item on n wheel tabs surrounding a wheel center in the wheel control, a display sequence of the at least one type of virtual item on the n wheel tabs corresponding to a sorting sequence of the at least one type of virtual item in the preparation interface, and n being a positive integer greater than 1.

2. The method according to claim 1, wherein:
a clockwise display sequence of the at least one type of virtual item on the n wheel tabs is the same as the sorting sequence of the at least one type of virtual item in the preparation interface; or
an anticlockwise display sequence of the at least one type of virtual item on the n wheel tabs is the same as the sorting sequence of the at least one type of virtual item in the preparation interface,
a starting tab for displaying the at least one type of virtual item being a first tab of the wheel control, and the first tab being a preset wheel tab in the n wheel tabs.

3. The method according to claim 2, wherein:
a quantity of the at least two types of virtual items is greater than or equal to n, the at least one type of virtual item comprises first n virtual items in the at least two types of virtual items, a clockwise display sequence of the first n virtual items on the n wheel tabs is the same as a sorting sequence of the first n virtual items in the preparation interface, and the first n virtual items are determined in the sorting sequence of the at least two types of virtual items in the preparation interface; or
a quantity of the at least two types of virtual items is k, the at least one type of virtual item comprises k virtual items, a clockwise display sequence of the k virtual items on k wheel tabs is the same as a sorting sequence of the k virtual items in the preparation interface, and k is a positive integer less than n; or
a quantity of the at least two types of virtual items is p, the at least one type of virtual item comprises p virtual items, a clockwise display sequence of the p virtual items on q wheel tabs is related to a sorting sequence of the p virtual items in the preparation interface, identical virtual items in the p virtual items are combined into the same wheel tab, p and q are positive integers less than n, and p is greater than q.

4. The method according to claim 1, wherein the sorting sequence of the at least two types of virtual items in the preparation interface comprises a sequence obtained by sorting the at least two types of virtual items in a sorting manner from left to right and from top to bottom in the preparation interface.

5. The method according to claim 1, wherein virtual items of different types or virtual items of the same type but comprising different state information are respectively displayed on different wheel tabs of the n wheel tabs,
the state information indicating a current state of the virtual item.

6. The method according to claim 1, wherein the displaying, in response to the wheel triggering operation, the wheel control comprises:
displaying, in response to a first wheel triggering operation, a first wheel control in the process in which the player-controlled virtual character performs the virtual activity; and/or
displaying, in response to a second wheel triggering operation, a second wheel control in the process in which the player-controlled virtual character performs the virtual activity,
a virtual item for a first functional use being displayed on the first wheel control, and a virtual item for a second functional use being displayed on the second wheel control.

7. The method according to claim 6, wherein the preparation interface is configured to display the at least two types of virtual items in at least two containers, and the at least two containers comprise at least two of the following: a first container, a second container, and a third container;
a clockwise display sequence of the virtual item for the first functional use in the first container on the n wheel tabs is the same as a sorting sequence of the virtual item for the first functional use in the first container; and
a start tab for displaying the virtual item for the first functional use in the second container is a next wheel tab of an end tab for displaying the virtual item for the first functional use in the first container, and a clockwise display sequence of the virtual item for the first functional use in the second container on the n wheel tabs is the same as a sorting sequence of the virtual item for the first functional use in the second container.

8. The method according to claim 7, wherein the displaying at least one type of virtual item on n wheel tabs surrounding the wheel center in the wheel control comprises:
displaying i virtual items for the first functional use in the first container and j virtual items for the first functional use in the second container on n wheel tabs surrounding a wheel center in the first wheel control, i and j being positive integers, i being less than or equal to n, and j being less than or equal to n−i.

9. The method according to claim 6, wherein the displaying, in response to the first wheel triggering operation, the first wheel control in the process in which the player-controlled virtual character performs the virtual activity comprises:
displaying, in response to long pressing on a first key, a medicine wheel control in the process in which the player-controlled virtual character performs the virtual activity;
the displaying at least one type of virtual item on n wheel tabs surrounding the wheel center in the wheel control comprises:
displaying at least one type of virtual item for a treatment-type functional use on the n wheel tabs surrounding the wheel center in the wheel control;
the displaying, in response to a second wheel triggering operation, a second wheel control in the process in which the player-controlled virtual character performs the virtual activity comprises:
displaying, in response to long pressing on a second key, a thrown item wheel control in the process in which the player-controlled virtual character performs the virtual activity; and
the displaying at least one type of virtual item on n wheel tabs surrounding the wheel center in the wheel control comprises:
displaying at least one type of virtual item for a throw-type functional use on the n wheel tabs surrounding the wheel center in the wheel control.

10. The method according to claim 1, wherein the method further comprises:
displaying the preparation interface again;
adjusting the sorting sequence of the at least one type of virtual item in the preparation interface;
displaying, after the preparation interface is exited, that the player-controlled virtual character performs the virtual activity in the virtual environment;
displaying, in response to the wheel triggering operation, the wheel control in the process in which the player-controlled virtual character performs the virtual activity; and
displaying the at least one type of virtual item on the n wheel tabs surrounding the wheel center in the wheel control, the display sequence of the at least one type of virtual item on the n wheel tabs corresponding to an adjusted sorting sequence of the at least one type of virtual item in the preparation interface.

11. The method according to claim 1, wherein the method further comprises:
setting, as a selected first virtual item, a virtual item corresponding to a wheel tab located in a first direction from the wheel center, in response to a movement control operation moving in the first direction; and
displaying, in response to a use operation for the first virtual item, that the player-controlled virtual character uses the first virtual item or holds the first virtual item,
the first direction comprising at least one of the following directions: top center, top right, middle right, bottom right, bottom center, bottom left, middle left, and top left.

12. The method according to claim 11, wherein the displaying, in response to the use operation for the first virtual item, that the player-controlled virtual character uses the first virtual item or holds the first virtual item comprises at least one of the following:
displaying, in response to an operation of clicking or tapping a first key for the first virtual item, that the player-controlled virtual character uses the first virtual item or holds the first virtual item; and
displaying, in response to an operation of releasing a key that is being long-pressed for the first virtual item, that the player-controlled virtual character uses the first virtual item or holds the first virtual item, the key that is being long-pressed being a key corresponding to the wheel triggering operation.

13. The method according to claim 12, wherein the method further comprises:
displaying, in a period in which the player-controlled virtual character continuously uses the first virtual item, in response to a clicking or tapping operation on a second key, that the player-controlled virtual character interrupts use of the first virtual item.

14. The method according to claim 13, wherein the method further comprises:
displaying, in a period in which the player-controlled virtual character holds the first virtual item, in response to a long-press operation on the first key, that the player-controlled virtual character prepares to throw the first virtual item, and displaying, in response to a releasing operation on the first key, that the player-controlled virtual character throws the first virtual item at a first height; and
displaying, in response to a long-press operation on the second key, that the player-controlled virtual character prepares to throw the first virtual item, and displaying, in response to a releasing operation on the second key, that the player-controlled virtual character throws the first virtual item at a second height, the second height being lower than the first height.

15. The method according to claim 12, wherein the method further comprises:
displaying, in a period in which the player-controlled virtual character holds the first virtual item, in response to an operation of switching the first virtual item that is currently held, that the player-controlled virtual character holds another virtual item.

16. A wheel display apparatus, comprising:
a processor; and
a memory storing instructions that, when executed by the processor, cause the apparatus to:
display a preparation interface comprising at least two types of virtual items carried by a player-controlled virtual character, and the at least two types of virtual items each corresponding to a sorting sequence;
display, after the preparation interface is exited, that the player-controlled virtual character performs a virtual activity in a virtual environment;
display, in response to a wheel triggering operation, a wheel control in a process in which the player-controlled virtual character performs the virtual activity; and
display at least one type of virtual item on n wheel tabs surrounding a wheel center in the wheel control, a display sequence of the at least one type of virtual item on the n wheel tabs corresponding to a sorting sequence of the at least one type of virtual item in the preparation interface, and n being a positive integer greater than 1.

17. The apparatus according to claim 16, wherein a clockwise display sequence of the at least one type of virtual item on the n wheel tabs is the same as the sorting sequence of the at least one type of virtual item in the preparation interface, a starting tab for displaying the at least one type of virtual item being a first tab of the wheel control, and the first tab being a preset wheel tab in the n wheel tabs.

18. The apparatus according to claim 16, wherein the instructions, when executed by the processor, further cause the system to display, in response to a first wheel triggering operation, a first wheel control in the process in which the player-controlled virtual character performs the virtual activity, a virtual item for a first functional use being displayed on the first wheel control.

19. A non-transitory computer-readable storage medium storing instructions that, when executed by a processor, cause the processor to:
display a preparation interface comprising at least two types of virtual items carried by a player-controlled virtual character, and the at least two types of virtual items each corresponding to a sorting sequence;
display, after the preparation interface is exited, that the player-controlled virtual character performs a virtual activity in a virtual environment;
display, in response to a wheel triggering operation, a wheel control in a process in which the player-controlled virtual character performs the virtual activity; and
display at least one type of virtual item on n wheel tabs surrounding a wheel center in the wheel control, a display sequence of the at least one type of virtual item on the n wheel tabs corresponding to a sorting sequence of the at least one type of virtual item in the preparation interface, and n being a positive integer greater than 1.

20. The non-transitory computer-readable storage medium according to claim 19, wherein a clockwise display sequence of the at least one type of virtual item on the n wheel tabs is the same as the sorting sequence of the at least one type of virtual item in the preparation interface, a starting tab for displaying the at least one type of virtual item being a first tab of the wheel control, and the first tab being a preset wheel tab in the n wheel tabs.
